(19) United States
(12) Patent Application Publication
(10) Pub. No.: US 2024/0340689 A1
(43) Pub. Date: Oct. 10, 2024

(54) TECHNIQUES FOR MANAGING LOCAL REMOTE USER EQUIPMENT IDENTIFIER

(71) Applicant: QUALCOMM Incorporated, San Diego, CA (US)

(72) Inventors: Peng CHENG, Beijing (CN); Karthika PALADUGU, Hyderabad (IN); Hong CHENG, Basking Ridge, NJ (US)

(21) Appl. No.: 18/294,726

(22) PCT Filed: Sep. 22, 2021
(86) PCT No.: PCT/CN2021/119509

§ 371 Date: Feb. 2, 2024

(51) Int. Cl. H04W 28/02; H04W 36/08; H04W 76/20; H04W 92/18

(52) U.S. Cl. CPC H04W 28/0273; H04W 36/08; H04W 76/20; H04W 92/18

(57) ABSTRACT

Methods, systems, and devices for wireless communication are described. A first user equipment (UE) may transmit, to a base station, a first uplink message including one or both of a protocol layer source identifier associated with a second UE or a request for a local identifier associated with the second UE. The first UE may receive, from the base station, a first downlink message including a downlink signal radio bearer (DL SRB) message, and the DL SRB message including one or both of the protocol layer source identifier associated with the second UE or the local identifier associated with the second UE in a downlink adaptation layer header of the DL SRB message. The first UE may transmit, to the second UE, in a sidelink adaptation layer header of a sidelink message, the local identifier associated with the second UE based in part on the received first downlink message.

### CROSS REFERENCE

The present application is a 371 national stage filing of International PCT Application No. PCT/CN2021/119509 by CHENG et al. entitled “TECHNIQUES FOR MANAGING LOCAL REMOTE USER EQUIPMENT IDENTIFIER,” filed Sep. 22, 2021, which is assigned to the assignee hereof, and which is expressly incorporated by reference in its entirety herein.

### FIELD OF TECHNOLOGY

The following relates to wireless communication, including techniques for managing local remote user equipment (UE) identifier.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as UE.

### SUMMARY

A wireless communications system may use relay technology to communicate from a base station to a relay UE and from the relay UE to a remote UE, and vice versa. Generally, the present disclosures relate to techniques for managing remote UE identification information. For example, the base station may assign or update identification information for the remote UE during, for example, an initial communications procedure, a handover procedure (e.g., path switching), a reconfiguration procedure, etc. In some examples, as part of an initial communications procedure, the relay UE may request identification information for the remote UE from the base station. In some cases, the relay UE may generate identification information for the remote UE and may transmit the generated identification information to the base station. In some examples, as part of a handover procedure to a target relay UE, the base station may transmit (e.g., as part of a handover command) identification information for the remote UE to the remote UE and/or the target relay UE. In some examples, as part of a reconfiguration procedure, the base station may transmit an updated identification information for the remote UE to the relay UE (e.g., during downlink transmissions) or may transmit an updated identification information for the remote UE to the remote UE (e.g., during uplink transmissions).

### BRIEF DESCRIPTION OF THE DRAWINGS

FIGS. 1 and 2 illustrate examples of wireless communications systems that support techniques for managing local remote UE identifier in accordance with aspects of the present disclosure.

FIGS. 3 through 8 illustrate example of process flows that support techniques for managing local remote UE identifier in accordance with aspects of the present disclosure.

FIGS. 9 and 10 show block diagrams of devices that support techniques for managing local remote UE identifier in accordance with aspects of the present disclosure.

FIG. 11 shows a block diagram of a communications manager that supports techniques for managing local remote UE identifier in accordance with aspects of the present disclosure.

FIG. 12 shows a diagram of a system including a device that supports techniques for managing local remote UE identifier in accordance with aspects of the present disclosure.

FIGS. 13 and 14 show block diagrams of devices that support techniques for managing local remote UE identifier in accordance with aspects of the present disclosure.

FIG. 15 shows a block diagram of a communications manager that supports techniques for managing local remote UE identifier in accordance with aspects of the present disclosure.

FIG. 16 shows a diagram of a system including a device that supports techniques for managing local remote UE identifier in accordance with aspects of the present disclosure.

FIGS. 17 through 19 show flowcharts illustrating methods that support techniques for managing local remote UE identifier in accordance with aspects of the present disclosure.

### DETAILED DESCRIPTION

A wireless communications system may use relay technology to communicate from a base station to a relay UE and from the relay UE to a remote UE, and vice versa. The base station may assign or update identification information (e.g., UE identifiers (IDs)) for the remote UE during, for example, an initial communications procedure, a handover procedure (e.g., path switching), a reconfiguration procedure, etc. The base station may transmit the identification information via system information (e.g., signal radio bearer type 0 (SRB0)) to a relay UE that relays the system information to the remote UE. In some cases, the relay UE may not receive the identification information. If the remote UE receives the identification information, then the relay UE and the remote UE may be misaligned. These scenarios may result in an inability to communicate, increased system latency, reduced reliability, and reduced user experience.

Various aspects of the present disclosure relate to managing (e.g., allocating, updating, etc.) remote UE identification information (e.g., local identifiers). A base station may assign or update identification information for a remote UE. As part of an initial communications procedure, a relay UE may request identification information (e.g., via sidelink UE information (SUI)) for the remote UE from the base station. The request may include a layer 2 (L2) source identifier for the remote UE. The base station may assign a local identifier and store a mapping for the assigned local identifier and the L2 source identifier for the remote UE. In some other examples, a relay UE may generate a local identifier for a remote UE and transmit the generated local identifier to a base station (e.g., via uplink (UL) SRB0). The base station may assign the generated local identifier to the remote UE and store a mapping for the assigned local identifier and a cell radio network temporary identifier (C-RNTI).

In other examples, as part of a handover procedure to a target relay UE (e.g., path switching from a direct to indirect path or between two indirect paths), a base station may transmit (e.g., as part of a handover command) identification information for a remote UE. The base station may transmit the identification information to the remote UE, to the target relay UE, or both. In some other examples, as part of a reconfiguration procedure, a base station may transmit an updated identification information for a remote UE to a relay UE (e.g., during downlink (DL) transmissions). The base station may transmit an updated identification information for the remote UE to the remote UE (e.g., during UL transmissions).

Aspects of the subject matter described herein may be implemented to realize one or more advantages. The present disclosure may support improvements in wireless communications systems by managing local remote UE identifiers and may improve wireless communication between base stations and UEs. In some examples, local remote UE identifier management, as described herein, may support higher data rates, thereby reducing latency and increasing reliability. As such, supported techniques may include improved device operations, and, in some examples, may promote efficiencies, among other benefits.

Aspects of the disclosure are initially described in the context of wireless communications systems. Aspects of the disclosure are further illustrated by and described with reference to apparatus diagrams, system diagrams, and flowcharts that relate to techniques for managing local remote UE identifier.

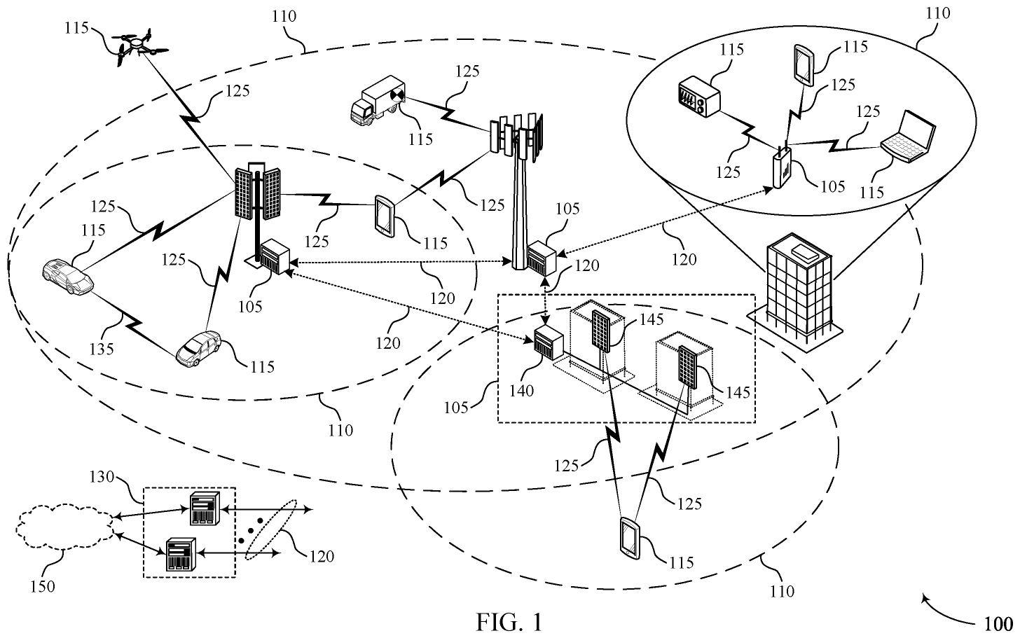

FIG. 1 illustrates an example of a wireless communications system 100 that supports techniques for managing local remote UE identifier in accordance with aspects of the present disclosure. The wireless communications system 100 may include one or more base stations 105, one or more UEs 115, and a core network 130. In some examples, the wireless communications system 100 may be an LTE network, an LTE-Advanced (LTE-A) network, an LTE-A Pro network, or an NR network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

A carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology). The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a LIE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

A base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support single-hope NR sidelink-based relay. In some examples, one or more base stations 105 or UEs 115 may support standalone (SA) operations for sidelink-based UE-to-network and UE-to-UE relay, and may support capability for layer 3 (L3) relay and L2 relay. In some examples, one or more base stations 105 or UEs 115 may support a relay (re-)selection criterion or a relay (re-)selection procedure, or both. In some other examples, one or more base stations 105 or UEs 115 may support a relay/remote UE 115 authorization. In other examples, one or more base stations 105 or UEs 115 may support a quality of service for relaying functionality, a service continuity, or a security of relayed connection, or any combination thereof. In some other examples, one or more base stations 105 or UEs 115 may support user plane protocol stack and control plane procedures (e.g., connection management of relayed connection). One or more base stations 105 or UEs 115 may support upper layer operations of discovery (model/procedure) for sidelink relaying.

An L2 relay control plane protocol stack may be described. A UE 115, relay UE 115 (UE-to-network), a base station 105, and a 5G core (5GC) network, may include one or more protocol stacks and each protocol stack may be associated with a respective radio access technology (RAT). For example, a first protocol stack may be associated with Uu technology. The first protocol stack may include a non-access stratum (NAS) layer, a Uu-RRC layer, a Uu-PDCP layer, an ADAPT layer (also referred to as an adaptation layer), a Uu-RLC layer, a Uu-MAC layer, a Uu-PHY layer, or any combination thereof. A second protocol stack may be associated with sidelink technology and may be referred to as a PC5 protocol stack. The second protocol stack may include a PC5-RLC layer, a PC5-MAC layer, a PC5-PHY layer, or any combination thereof. A third protocol stack may be a control plane (N2) stack. In some examples the remote UE 115, the relay UE 115, the base station 105, and the 5GC network, may include any combination of the first protocol stack, the second protocol stack, and the third protocol stack.

A remote UE 115 may be in communication with a relay UE 115, a base station 105, a 5GC network, or any combination thereof. The base station may also be in communication with the relay UE 115 and the 5GC network. In some cases, a NAS layer of the remote UE 115 may be in electronic communication with the NAS layer of the 5GC. In some cases, the Uu-RRC of the remote UE 115 may be in electronic communication with the Uu-RRC layer of the base station 105 and the Uu-PDCP of the remote UE 115 may be in electronic communication with the with the Ut-PDCP of the base station 105. In some cases, the ADAPT layer, the PC5-RLC layer, the PC5-MAC layer, and the PC5-PHY layer of the remote UE 115 may be in electronic communication with the ADAPT layer, the PC5-RLC layer, the PC5-MAC layer, and the PC5-PHY layer of the relay UE 115. In some cases, the ADAPT layer, the Uu-RLC layer, the Uu-MAC layer, and the Uu-PHY layer of the relay UE 115 may be in electronic communication with the ADAPT layer, the Uu-RLC layer, the Uu-MAC layer, and the Uu-PHY layer of the base station 105. In some cases, the N2 stack of the base station may be in electronic communication with the N2 stack of the 5GC network.

An adaptation layer on PC5 may support bearer mapping. In some cases, a serving base station 105 of a relay UE 115 may assign a local/temp remote UE identifier. In some cases, for SRB0, an adaptation layer may be present over a Uu hop for uplink. In some cases, for SRB0, an adaptation layer may be present over a Uu hop for downlink. In some examples, the UEs 115 and the base stations 105 of the wireless communications system 100 may be configured to support improved techniques for managing remote UE identification information. The wireless communications system 100 may provide for managing remote UE identification information at a base station 105, a relay UE 115, and a remote UE 115, which may enable accurate communication within the wireless communications system 100, decrease system latency, improve reliability, and enhance user experience, among other advantages.

For example, a relay UE 115 of the wireless communications system 100 may be configured to relay (e.g., forward) communications between a base station 105 and a remote UE 115. In some cases, the base station of the wireless communications system 100 may manage (e.g., assign, update, etc.) identification information for the remote UE 115. For instance, as part of an initial communications procedure, the base station may assign a local identifier for the remote UE 115 and store a mapping between the local identifier and a protocol layer identifier (e.g., L2 source identifier, C-RNTI, etc.) of the remote UE 115.

In some examples, a network (e.g., base station 105) may determine that a remote UE 115 is to perform a handover procedure and/or reselection procedure from a relay UE 115. The handover procedure may be part of a path switch from a direct path to an indirect path, an indirect path to an indirect path, or any combination thereof. The base station may transmit identification information for the remote UE. In some cases, a target relay UE 115 may be in a specific state (e.g., idle, inactive, connected, etc.). If the target relay UE 115 is in a connected state, the base station may transmit a control message to the target relay UE 115, where the control message may include identification information for the remote UE. If the target relay UE 115 is in an idle state or an inactive state, the base station may transmit a control message to the remote UE 115, where the control message may include identification information for the remote UE. In some examples, a base station 105 may initiate a reconfiguration procedure. The base station 105 may update identification information for a remote UE 115. In some cases (e.g., during DL transmissions), the base station may transmit the updated identification information to a relay UE 115. In some cases (e.g., during UL transmissions), the base station may transmit the updated identification information to the remote UE 115.

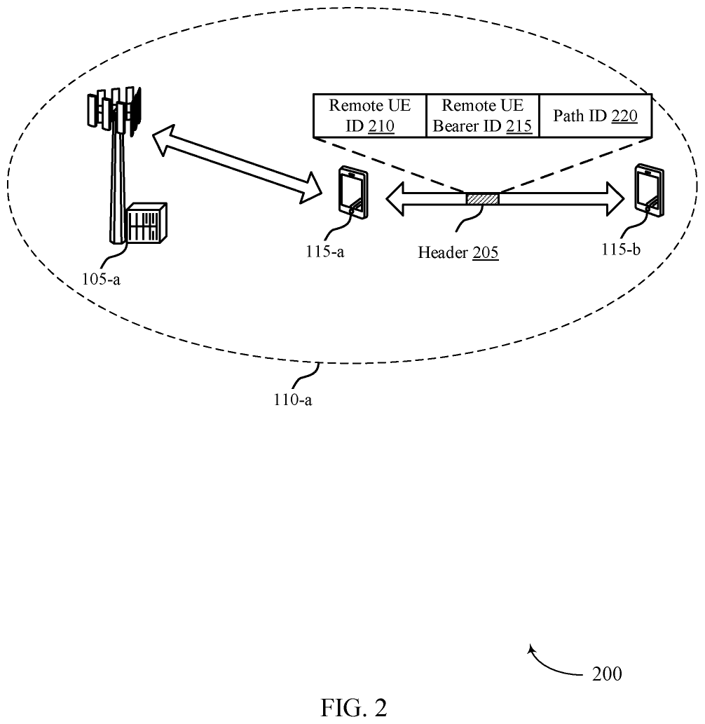

FIG. 2 illustrates an example of a wireless communications system 200 that supports techniques for managing local remote UE identifier in accordance with aspects of the present disclosure. In some examples, the wireless communications system 200 may implement aspects of the wireless communications system 100. The wireless communications system 200 may include a UE 115 a and UE 115-b, which may be examples of a UE 115, as described herein with reference to FIG. 1. In the example of FIG. 2, the UE 115-a may be referred to as a relay UE 115, while the UE 115-b may be referred to as a remote UE 115, as described herein with reference to FIG. 1. A base station 105-a may communicate with the UE 115-a, the UE 115-b, or both. In some examples, the UE 115-a may relay wireless communications between the base station 105-a and the UE 115-b.

The UE 115-a may be in sidelink communication (e.g., via a PC5 interface) with the UE 115-b. In some examples, the sidelink communication may include a header 205 (e.g., a PC5 adaptation layer header) that may facilitate managing identification information, among other uses. The header 205 may include a remote UE local identifier 210 (e.g., RemoteUEndex), a remote UE bearer identifier 215 (e.g., RemoteUEBearerID), a path identifier 220 (e.g., PathID), or any combination thereof. In some cases, the remote UE bearer identifier 215 may be present, the remote UE local identifier 210 may be optionally present, and the path identifier 220 may be optionally present. In some cases, the base station 105-a may be in wireless communication with the UE 115-a (e.g., a relay UE) for managing identification information for the UE 115-b (e.g., remote UE).

The base station 105-a may configure or update a remote UE local identifier 210. For example, as part of a reconfiguration procedure or handover procedure (e.g., for a handover command), the base station 105-a may configure or update the remote UE local identifier 210 to the UE 115-b in a control message (e.g., an RRC reconfiguration message). In some cases, the base station 105-a may update a remote UE bearer identifier 215 and inform both the UE 115-a and the UE 115-b. For example, the base station 105-a, the UE 115-a, and the UE 115-b may perform a sidelink connection setup (e.g., sidelink L2 relay connection setup). The base station 105-a may update the remote UE bearer identifier 215 and transmit the updated remote UE bearer identifier 215 to the UE 115-a and the UE 115-b via, for example, a control message (e.g., an RRC reconfiguration message).

In some cases, assigning identification information (e.g., remote UE local identifier 210) to the UE 115-a and the UE 115-b for delivery of system information (e.g., SRB0) may not be clearly defined. In some cases, if the base station 105-a may have to configure a remote UE local identifier 210 to both the UE 115-a and the UE 115-b, the configuration may cause a misalignment on the remote UE local identifier 210 between the UE 115-b and the UE 115-a. To avoid such issues, the base station 105-a may assign or update identification information for the UE 115-b during, for example, an initial communications procedure, a handover procedure (e.g., path switching), a reconfiguration procedure, etc.

In some examples, as part of an initial communications procedure, a procedure of a remote UE local identifier assignment for system information (e.g., SRB0) may be defined. For example, to request the UE 115-b local identifier (e.g., remote UE local identifier 210), the UE 115-a may send uplink system information (e.g., SUI) with the UE 115-b protocol layer (e.g., L2) source identifier to the base station 105-a. In some cases, the UE 115-a may generate a random remote UE 115-b local identifier (e.g., a random remote UE local identifier 210) and may send uplink system information (e.g., UL Uu adaptation layer header) with the generated random remote UE 115-b local identifier to the base station. In some other examples, as part of a handover procedure to the UE 115-a (e.g., a target relay UE), a procedure of a remote UE local identifier assignment in path switching from a direct path to an indirect path, an indirect to an indirect path, or any combination thereof, may be defined. For example, the base station 105-a may include (e.g., as part of a handover command) a remote UE 115-b local identifier (e.g., remote UE local identifier 210), and, optionally, the base station 105-a may configure the remote UE 115-b local identifier to the UE 115-a.

In other examples, as part of a reconfiguration procedure, a procedure of a remote UE local identifier update when a remote UE local identifier 210 is present in a sidelink (e.g., PC5) adaptation layer header may be defined. For example, in downlink, the base station 105-a may update the UE 115-a with an updated remote UE 115-b local identifier (e.g., remote UE local identifier 210) via a control message (e.g., RRCReconfiguration). The UE 115-a may relay the updated remote UE 115-b local identifier to the UE 115-b. After the UE 115-b may receive the updated remote UE 115-b local identifier, the UE 115-b may update a remote UE local identifier 210 for the UE 115-b. In some examples, for uplink, the base station 105-a may update the UE 115-b with an updated remote UE local identifier 210 for the UE 115-b via a control message (e.g., RRCReconfiguration). The UE 115-b may transmit a sidelink (e.g., PC5) adaptation layer header with the updated remote UE local identifier 210 to the UE 115-a. After the UE 115-a may receive the updated remote UE local identifier 210, the UE 115-a may update a remote UE local identifier 210 for the UE 115-b.

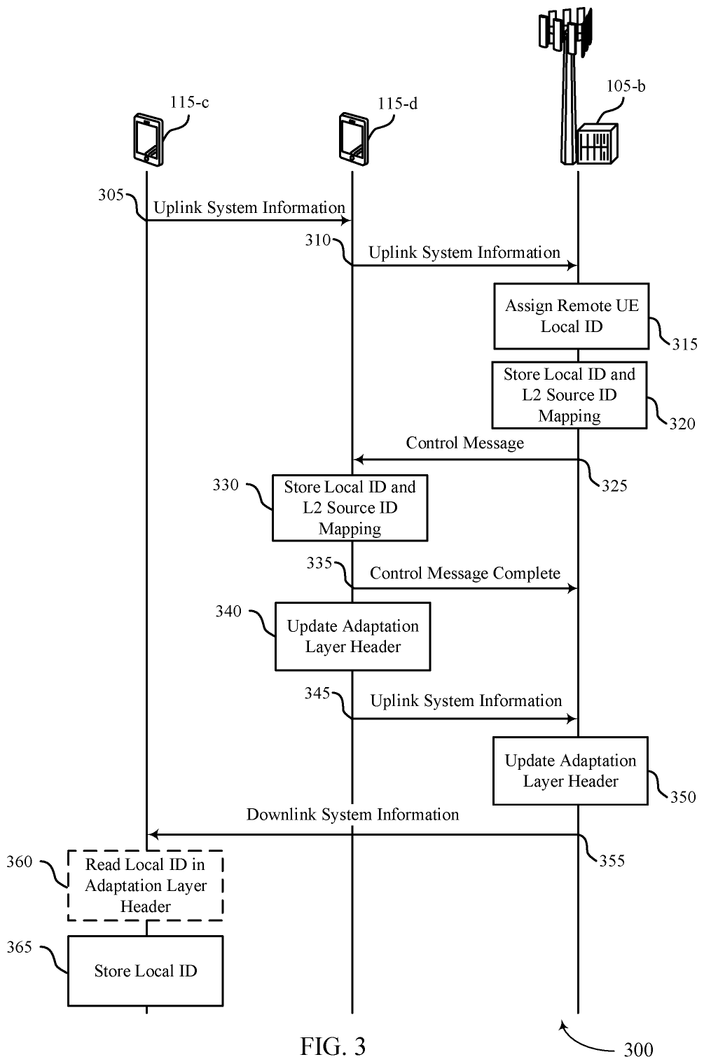

FIG. 3 illustrates an example of a process flow 300 that supports techniques for managing local remote UE identifier in accordance with aspects of the present disclosure. The process flow 300 may implement aspects of the wireless communications system 100, the wireless communications system 200, or both. For example, the process flow 300 may include a base station 105-b, a UE 115-c, and a UE 115-d, which may be respective examples of base stations 105 and UEs 115 as described with reference to FIGS. 1 and 2. In the example of FIG. 3, the UE 115-c may be referred to as a remote UE 115, while the UE 115-d may be referred to as a relay UE 115. In the following description of the process flow 300, operations between one or more of the base station 105-b, the UE 115-c, or the UE 115-d may occur in a different order or at different times than as shown. Some operations may also be omitted from the process flow 300, and other operations may be added to the process flow 300.

At 305, the UE 115-c may transmit a first uplink system information message to the UE 115-d. In some examples, the first uplink system information message may be an uplink SRB0. In some other examples, the uplink SRB0 may be an RRC control message (e.g., RRCSetupRequest, RRCResumeRequest, RRCReestablishmentRequest, etc.). Upon reception of the uplink SRB0 message (e.g., Uu SRB0 message, PC5 SRB0 message), at 310, the UE 115-d may transmit a second uplink system information message (e.g., a SUI) to the base station 105-b. The second uplink system information message (e.g., SidelinkUEInformationNR) may include a protocol layer source identifier (e.g., L2 source identifier) for the UE 115-c and an indication to request a remote UE local identifier.

At 315, the base station 105-b may assign a remote UE local identifier based on the indication in the second uplink system information message. In some examples, the remote UE local identifier may be an example of a remote UE local identifier 210 as described with reference to FIG. 2. At 320, the base station 105-b may build a mapping between the protocol layer source identifier and the remote UE local identifier. The base station 105-b may store the mapping. The base station 105-b may include the mapping in a control message (e.g., RRCReconfiguration). At 325, the base station 105-b may transmit the control message to the UE 115-d.

At 330, the UE 115-d may associate a previously established sidelink link (e.g., PC5 link), with a protocol layer (e.g., L2) source identifier mapping for the UE 115-c, with the mapping included in the control message. At 335, the UE 115-d may transmit a control message complete (e.g., RRCReconfigurationComplete) to the base station 105-b. The UE 115-d may configure a sidelink (e.g., PC5) RLC, corresponding to the previously established sidelink link, with the UE 115-c local identifier and a relaying configuration received from the base station 105-b. At 340, the UE 115-d may update an adaptation layer header. The adaptation layer header may be an uplink adaptation header and may include the UE 115-c local identifier.

At 345, the UE 115-d may transmit a third uplink system information message to the base station 105-b. The third uplink system information message may include the first uplink system information message from the UE 115-c. In some examples, the UE 115-d may relay the first uplink system information message to the base station 105-b. At 350, the base station 105-b may update an adaptation layer header. The updating may include the UE 115-c local identifier in the adaptation layer header. In some examples, the adaptation layer header may be a downlink access link adaptation layer header.

At 355, the base station 105-b may transmit a downlink system information (e.g., SRB0) response message that may include a downlink sidelink (e.g., PC5) adaptation layer header. In some examples, the downlink system information response message may include a same UE 115-c local identifier as in the downlink access link adaptation layer header. In some cases, if the UE 115-c local identifier is absent in the downlink sidelink adaptation layer header, the downlink system information response message may include the mapping for the UE 115-c. Optionally, at 360, if the UE 115-c local identifier is present in the downlink sidelink adaptation layer header, the UE 115-c may read the UE 115-c local identifier in the downlink sidelink adaptation layer header of the downlink system information response message.

At 365, the UE 115-c may store the UE 115-c local identifier. Therefore, the UE 115-c may receive the UE 115-c local identifier assigned by the base station 105-b. In subsequent transmissions (e.g., following signaling radio bearer (SRB) or data radio bearer (DRB) messages), the UE 115-c may include the UE 115-c local identifier in a sidelink (e.g., PC5) adaptation layer header. In some cases, the process flow 300 and the signaling in the second uplink system information may support increased signaling reliability.

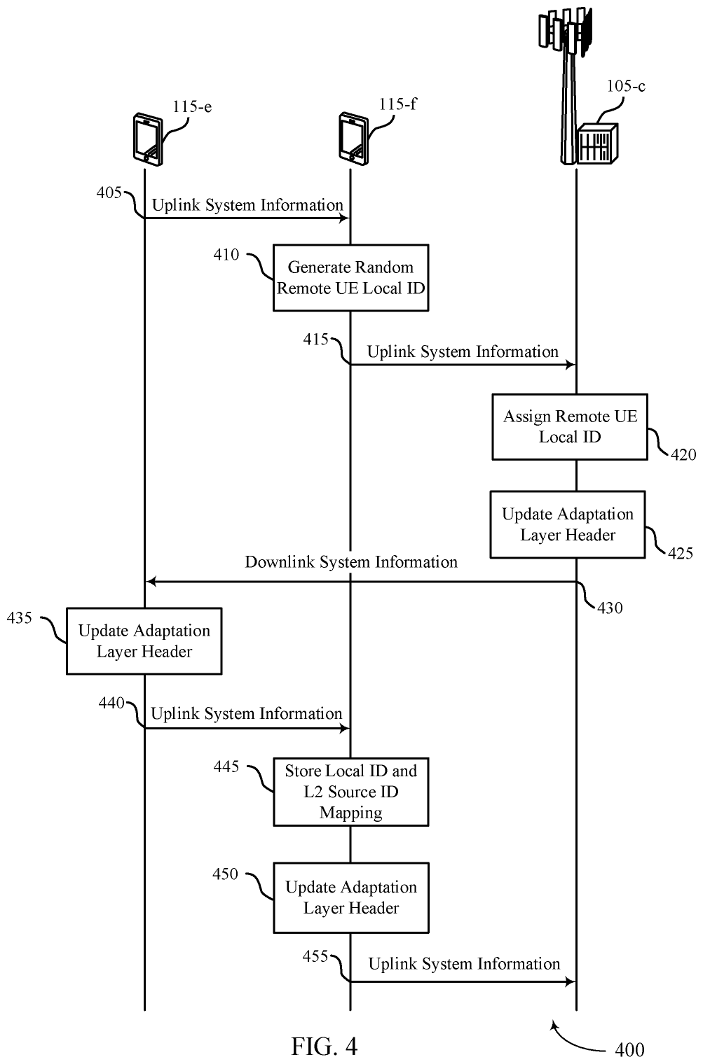

FIG. 4 illustrates an example of a process flow 400 that supports techniques for managing local remote UE identifier in accordance with aspects of the present disclosure. The process flow 400 may implement aspects of the wireless communications system 100, the wireless communications system 200, or both. For example, the process flow 400 may include a base station 105-c, a UE 115-e, and a UE 115-f, which may be respective examples of base stations 105 and UEs 115 as described with reference to FIGS. 1 through 3. In the example of FIG. 4, the UE 115-e may be referred to as a remote UE 115, while the UE 115-f may be referred to as a relay UE 115. In the following description of the process flow 400, operations between one or more of the base station 105-c, the UE 115-e, or the UE 115-f may occur in a different order or at different times than as shown. Some operations may also be omitted from the process flow 400, and other operations may be added to the process flow 400.

At 405, the UE 115-e may transmit a first uplink system information message to the UE 115-f. In some cases, the first uplink system information message may be an uplink SRB0. Upon reception of the uplink SRB0 message (e.g., Uu SRB0 message), at 410, the UE 115-f may generate a random remote UE local identifier and include the generated random remote UE local identifier in a second uplink system information message (e.g., uplink SRB0 message of the UE 115-e), where the generated random remote UE local identifier may be included in an uplink adaptation layer header of the second uplink system information message. In some examples, the generated random remote UE local identifier may be used by the UE 115-f to route a downlink response system information (e.g., SRB0) message towards different remote UEs 115, which may initialize SRB0 in a similar time. In some cases, the second uplink system information message may include the first uplink system information message. At 415, the UE 115-f may transmit the second uplink system information message to the base station 105-c.

At 420, the base station 105-c may assign a remote UE local identifier based on the generated random remote UE local identifier. The base station 105-c may build a mapping between the remote UE local identifier and a C-RNTI associated with the UE 115-e based on the generated random remote UE local identifier. At 425, the base station 105-c may update an adaptation layer header. The adaptation layer header may be a downlink adaptation layer header and may include a same remote UE local identifier as the uplink adaptation layer header. At 430, the base station 105-c may transmit a downlink system information (e.g., SRB0) response message to the UE 115-f. The downlink system information response message may include the downlink adaptation layer header, the assigned remote UE local identifier, and the C-RNTI. The UE 115-f may determine a target UE (e.g., the UE 115-e) based on the assigned remote UE local identifier. In some cases, if a sidelink (e.g., PC5) adaptation layer is configured between the UE 115-f and the UE 115-e and if the assigned remote UE local identifier is present in the sidelink adaptation layer header, at 435, the UE 115-e may update a sidelink adaptation layer header. The updated sidelink adaptation layer header may be an uplink sidelink adaptation layer header and may be included in subsequent transmissions (e.g., following SRB or DRB messages). At 440, the UE 115-e may transmit a third uplink system information (e.g., SRB or DRB) message, where the updated sidelink uplink adaptation layer header and a protocol layer (e.g., L2) source identifier may be included.

At 445, the UE 115-f may obtain the assigned remote UE local identifier from the updated sidelink uplink adaptation layer header and may store a mapping between the assigned remote UE local identifier and the protocol layer source identifier. At 450, the UE 115-f may update an access link uplink adaptation layer header (e.g., Uu adaptation layer header). At 455, the UE 115-f may transmit the assigned remote UE local identifier in a fourth uplink system information (e.g., SRB or DRB) message, where the access link uplink adaptation layer header may be included.

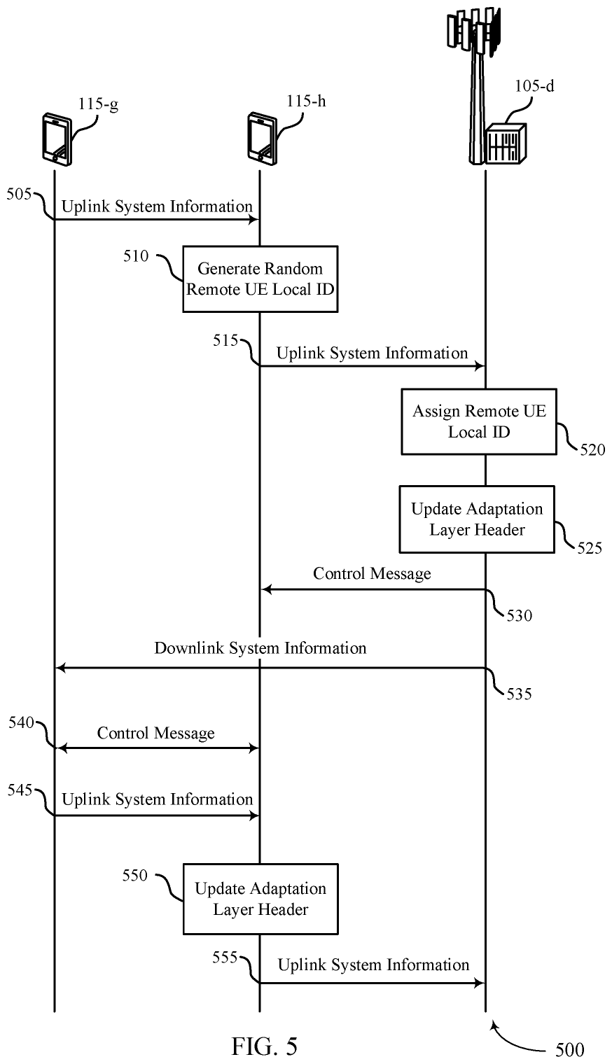

FIG. 5 illustrates an example of a process flow 500 that supports techniques for managing local remote UE identifier in accordance with aspects of the present disclosure. The process flow 500 may implement aspects of the wireless communications system 100, the wireless communications system 200, or both. For example, the process flow 500 may include a base station 105-d, a UE 115-g, and a UE 115-h, which may be respective examples of base stations 105 and UEs 115 as described with reference to FIGS. 1 through 4. In the example of FIG. 4, the UE 115-g may be referred to as a remote UE 115, while the UE 115-h may be referred to as a relay UE 115. In the following description of the process flow 500, operations between one or more of the base station 105-d, the UE 115-g, or the UE 115-h may occur in a different order or at different times than as shown. Some operations may also be omitted from the process flow 500, and other operations may be added to the process flow 500.

At 505, the UE 115-g may transmit a first uplink system information message to the UE 115-h. The first uplink system information message may be an uplink SRB0. Based on receiving the uplink SRB0 message (e.g., Uu SRB0 message), at 510, the UE 115-h may generate a random remote UE local identifier and include the generated random remote UE local identifier in a second uplink system information message (e.g., uplink SRB0 message of the UE 115-g), where the generated random remote UE local identifier may be included in an uplink adaptation layer header of the second uplink system information message. In some examples, the generated random remote UE local identifier may be used by the UE 115-h to route a downlink response system information (e.g., SRB0) message towards different remote UEs 115, which may initialize SRB0 in a similar time. The second uplink system information message may include the first uplink system information message. At 515, the UE 115-h may transmit the second uplink system information message to the base station 105-d.

At 520, the base station 105-d may assign a remote UE local identifier based on the generated random remote UE local identifier. The base station 105-d may build a mapping between the assigned remote UE local identifier and a C-RNTI associated with the UE 115-g based on the generated random remote UE local identifier. At 525, the base station 105-d may update an adaptation layer header. The adaptation layer header may be a downlink adaptation layer header and may include a same remote UE local identifier as the uplink adaptation layer header. Optionally, at 530, a sidelink (e.g., PC5) adaptation layer may not be configured between the UE 115-h and the UE 115-g and the assigned remote UE local identifier may not be present in the sidelink adaptation layer. The base station 105-d may transmit a control message (e.g., a Uu RRC Reconfiguration message), as part of a relaying configuration, to the UE 115-h. In some cases, the control message may include the assigned remote UE local identifier.

At 535, the base station 105-d may transmit a downlink system information (e.g., SRB0) response message to the UE 115-h. The downlink system information response message may include the downlink adaptation layer header, the assigned remote UE local identifier, and the C-RNTI. The UE 115-h may determine a target UE (e.g., the UE 115-g) based on the assigned remote UE local identifier. In some cases, if a sidelink (e.g., PC5) adaptation layer is not configured between the UE 115-h and the UE 115-g and if the assigned remote UE local identifier is not present in the sidelink adaptation layer header, at 540, the UE 115-h and the UE 115-g may share control messages (e.g., PC5 RRC reconfiguration messages). In some cases, the UE 115-g may indicate the assigned remote UE local identifier via one or more of the control messages to the UE 115-h. The UE 115-g may update a sidelink adaptation layer header. The updated sidelink adaptation layer header may be an uplink sidelink adaptation layer header and may be included in subsequent transmissions (e.g., following SRB or DRB messages). At 545, the UE 115-g may transmit a third uplink system information (e.g., SRB or DRB) message.

At 550, the UE 115-h may update an access link uplink adaptation layer header (e.g., Uu adaptation layer header) based on the assigned remote UE local identifier. The UE 115-h may store a mapping between the assigned remote UE local identifier and the protocol layer source identifier. At 555, the UE 115-h may transmit the assigned remote UE local identifier in a fourth uplink system information (e.g., SRB or DRB) message, where the access link uplink adaptation layer header may be included.

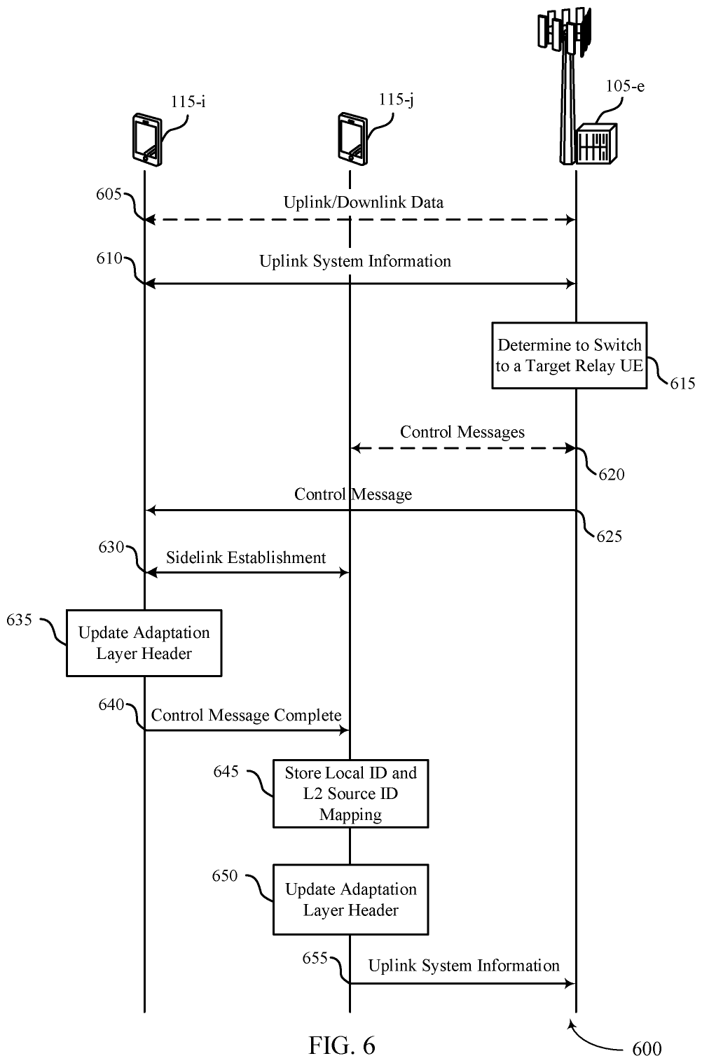

FIG. 6 illustrates an example of a process flow 600 that supports techniques for managing local remote UE identifier in accordance with aspects of the present disclosure. The process flow 400 may implement aspects of the wireless communications system 100, the wireless communications system 200, or both. For example, the process flow 600 may include a base station 105-e, a UE 115-i, and a UE 115-j, which may be respective examples of base stations 105 and UEs 115 as described with reference to FIGS. 1 through 5. In the example of FIG. 6, the UE 115-i may be referred to as a remote UE 115, while the UE 115-j may be referred to as a relay UE 115. In the following description of the process flow 600, operations between one or more of the base station 105-e, the UE 115-i, and the UE 115-j may occur in a different order or at different times than as shown. Some operations may also be omitted from the process flow 600, and other operations may be added to the process flow 600.

At 605, the UE 115-i may be in wireless communication with (e.g., coupled to) the UE 115-j. The UE 115-j may provide for the relay of uplink and downlink data between the base station 105-e and the UE 115-i. At 610, the UE 115-i and the base station 105-e may be in wireless communication. The wireless communication may include measuring, configuring, and reporting system information. In some cases, based on the system information, at 615, the base station 105-e may determine to initiate a handover procedure. The handover procedure may include switching to a target relay UE 115 (e.g., the UE 115-j). In some cases, the UE 115-j may be in a respective operating state, which may include an IDLE state, an INACTIVE state, or a CONNECTED state. At 620, if the UE 115-j is in a CONNECTED state, the UE 115-j and the base station 105-e may exchange control messages. The control messages may include an RRC Reconfiguration and RRC Reconfiguration Complete message. In some cases, one or more of the control messages may optionally include a remote UE local identifier. At 625, the base station 105-e may transmit a control message to the UE 115-i. In some cases, the control message may be an RRC Reconfiguration message as part of a handover command. In some cases, the control message may include the remote UE local identifier and a protocol layer (e.g., L2) source identifier.

At 630, the UE 115-i and the UE 115-j may perform a sidelink establishment procedure. The sidelink establishment procedure may be based on a default configuration. For example, the default configuration may be a sidelink (e.g., PC5) RLC configuration used to send a control message complete (e.g., RRCReconfigurationcomplete). The default configuration may be based on the protocol layer source identifier and used if the UE 115-j is in an IDLE state or an INACTIVE state. Elsewise, a different configuration may be used. For example, the different configuration may be a sidelink (e.g., PC5) RLC configuration that may be indicated in the control messages, at 620, from the base station 105-e. In some cases, the different configuration may be based on the remote UE local identifier and used if the UE 115-j is in a CONNECTED state. At 635, the UE 115-i may update an adaptation layer header. In some cases, the adaptation layer header may be an uplink sidelink (e.g., PC5) adaptation layer header. The uplink sidelink adaptation layer header may be updated according to the remote UE local identifier.

At 640, the UE 115-i may transmit a control message complete (e.g., RRCReconfigurationcomplete) to the UE 115-j. The control message complete may include the uplink sidelink adaptation layer header, where the uplink sidelink adaptation layer header may include the remote UE local identifier. After the UE 115-j may receive the control message complete (e.g., RRCReconfigurationcomplete) from the UE 115-i with the uplink sidelink adaptation layer header, the UE 115-j may obtain the remote UE local identifier. At 645, the UE 115-j may build a mapping between the remote UE local identifier and the protocol layer source identifier and store the mapping. The UE 115-j may include the remote UE local identifier in an uplink access link (e.g., Uu) adaptation layer header. At 655, the UE 115-j may transmit uplink system information to the base station 105-e. In some cases, the uplink system information may include the remote UE local identifier in an uplink access link adaptation header. In some examples, the uplink system information may complete the handover procedure.

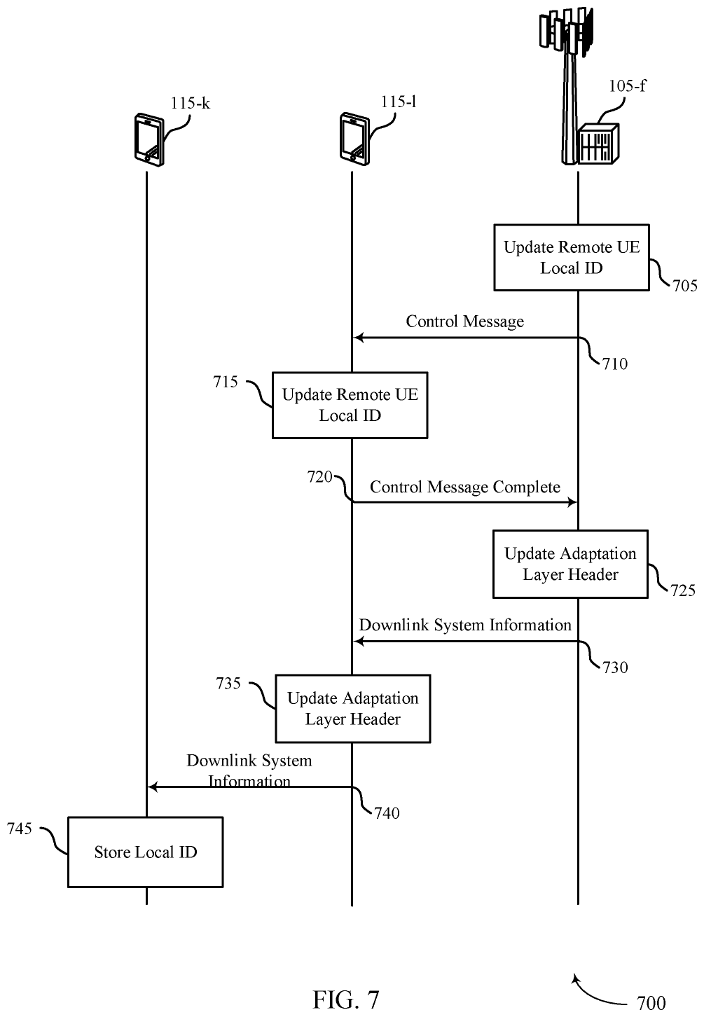

FIG. 7 illustrates an example of a process flow 700 that supports techniques for managing local remote UE identifier in accordance with aspects of the present disclosure. The process flow 400 may implement aspects of the wireless communications system 100, the wireless communications system 200, or both. For example, the process flow 700 may include a base station 105-f, a UE 115-k, and a UE 115-l, which may be respective examples of base stations 105 and UEs 115 as described with reference to FIGS. 1 through 6. In the example of FIG. 7, the UE 115-k may be referred to as a remote UE 115, while the UE 115-l may be referred to as a relay UE 115. In the following description of the process flow 700, operations between one or more of the base station 105-f, the UE 115-k, and the UE 115-l may occur in a different order or at different times than as shown. Some operations may also be omitted from the process flow 700, and other operations may be added to the process flow 700.

The base station 105-f may update a remote UE local identifier and may inform both the UE 115-l and the UE 115-k about the update via a control message (e.g., RRC reconfiguration message). In some cases, if the UE 115-k received the updated remote UE local identifier and used the updated remote UE local identifier in an adaptation layer header, but the UE 115-l (coupled to the UE 115-k) did not receive the updated remote UE local identifier, then the different remote UE local identifiers may cause misalignment on the remote UE local identifier between the UE 115-k and the UE 115-l. In some cases (e.g., when a remote UE local identifier may be present in a sidelink adaptation layer header), to lessen the probability of misalignment, the base station 105-f may manage a remote UE local identifier.

In some examples, the base station 105-f may have to update the UE 115-l on an updated remote UE local identifier via a control message (e.g., RRCReconfiguration). For example, during a downlink communication, at 705, the base station 105-f may update the remote UE local identifier associated with the UE 115-k. In some cases, the UE 115-l may be in a CONNECTED state. At 710, the base station 105-f may transmit a control message to the UE 115-l. The control message may be an RRCReconfiguration message, where the control message may include a previous remote UE local identifier associated with the UE 115-k and the updated remote UE local identifier.

At 715, the UE 115-l may update the previous remote UE local identifier based on the updated remote UE local identifier. At 720, the UE 115-l may transmit a control message complete (e.g., RRCReconfigurationcomplete) to the base station 105-f. At 725, the base station 105-f may update an adaptation layer header with the updated remote UE local identifier. In some cases, the adaptation layer header may be a downlink access link adaptation layer header. At 730, the base station 105-f may transmit a first downlink system information message to the UE 115-l. The first downlink system information message may include the adaptation layer header.

At 735, the UE 115-l may update an adaptation layer header associated with the UE 115-l, based on the updated remote UE local identifier. In some cases, the adaptation layer header may be a downlink sidelink (e.g., PC5) adaptation layer header. At 740, the UE 115-l may transmit a second downlink system information message. The second downlink system information message may include a same remote UE local identifier as the updated remote UE local identifier. The same remote UE local identifier may be included in the updated adaptation layer header associated with the UE 115-l. At 745, the UE 115-k may store the updated remote UE local identifier, based on receiving the second downlink system information message. For example, after receiving the updated remote UE local identifier from the downlink sidelink adaptation layer header in the second downlink system information message, the UE 115-k may update a previous remote UE local identifier associated with the UE 115-k with the updated remote UE local identifier.

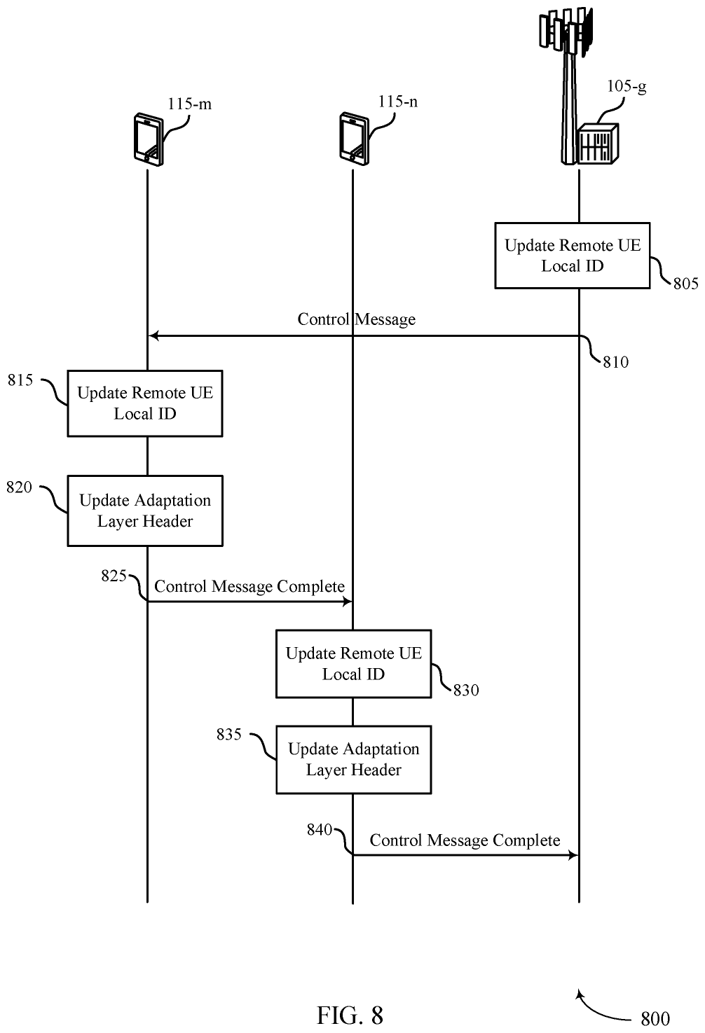

FIG. 8 illustrates an example of a process flow 800 that supports techniques for managing local remote UE identifier in accordance with aspects of the present disclosure. The process flow 400 may implement aspects of the wireless communications system 100, the wireless communications system 200, or both. For example, the process flow 800 may include a base station 105-g, a UE 115-m, and a UE 115-n, which may be respective examples of UEs 115 and base stations 105 as described with reference to FIGS. 1 through 7. In the example of FIG. 8, the UE 115-m may be referred to as a remote UE 115, while the UE 115-n may be referred to as a relay UE 115. In the following description of the process flow 800, operations between one or more of the base station 105-g, the UE 115-m, and the UE 115-n may occur in a different order or at different times than as shown. Some operations may also be omitted from the process flow 800, and other operations may be added to the process flow 800.

The base station 105-g may update a remote UE local identifier and may inform both the UE 115-n and the UE 115-m about the update via a control message (e.g., RRC reconfiguration message). In some cases, if the UE 115-m received the updated remote UE local identifier and used the updated remote UE local identifier in an adaptation layer header, but the UE 115-n (coupled to the UE 115-m) did not receive the updated remote UE local identifier, then the different remote UE local identifiers may cause misalignment on the remote UE local identifier between the UE 115-m and the UE 115-n. In some cases (e.g., when a remote UE local identifier may be present in a sidelink adaptation layer header), to lessen the probability of misalignment, the base station 105-g may manage a remote UE local identifier. The base station 105-g may have to update the UE 115-m on an updated remote UE local identifier via a control message (e.g., RRCReconfiguration). For example, during an uplink communication, at 805, the base station 105-g may update the remote UE local identifier associated with the UE 115-m. In some cases, the UE 115-n may be in a CONNECTED state.

At 810, the base station 105-g may transmit a control message to the UE 115-m. The control message may be an RRCReconfiguration message, where the control message may include a previous remote UE local identifier associated with the UE 115-m and the updated remote UE local identifier. At 815, the UE 115-m may update the previous remote UE local identifier based on the updated remote UE local identifier. At 820, the UE 115-m may update an adaptation layer header with the updated remote UE local identifier. In some cases, the adaptation layer header may be an uplink sidelink adaptation layer header. At 820, the UE 115-m may transmit a control message complete (e.g., RRCReconfigurationcomplete) to the UE 115-n. In some cases, the control message complete may include the updated remote UE local identifier in the uplink sidelink adaptation layer header.

At 830, the UE 115-n may update a previous remote UE local identifier based on the updated remote UE local identifier. The UE 115-n may store the updated remote UE local identifier, based on receiving the control message complete. For example, after receiving the updated remote UE local identifier from the uplink sidelink adaptation layer header in the control message complete, the UE 115-n may update a previous remote UE local identifier associated with the UE 115-m with the updated remote UE local identifier. At 835, the UE 115-n may update an adaptation layer header with the updated remote UE local identifier. In some cases, the adaptation layer header may be an uplink access link adaptation layer header. At 840, the UE 115-n may transmit a control message complete (e.g., RRCReconfigurationcomplete) to the base station 105-g, where the control message may include the uplink access link adaptation layer header. In some cases, the control message complete may include the updated remote UE local identifier in the uplink access link adaptation layer header.

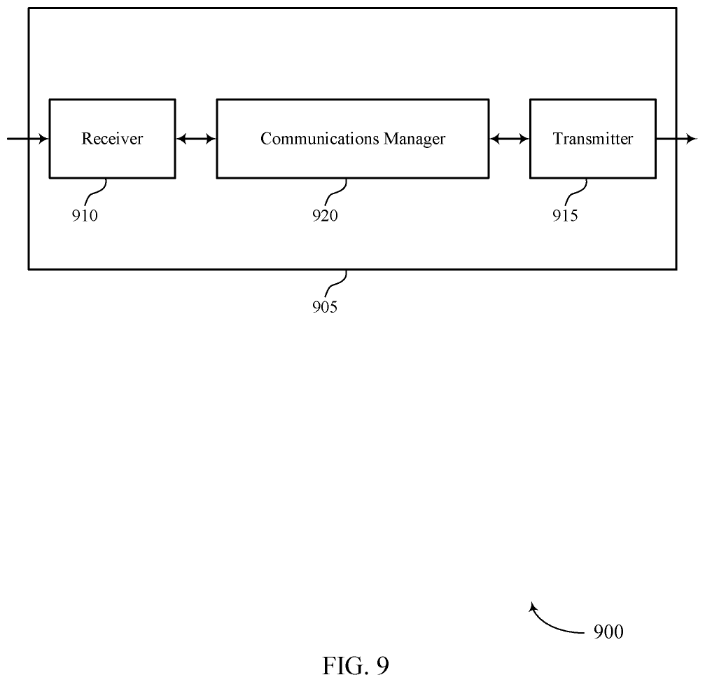

FIG. 9 shows a block diagram 900 of a device 905 that supports techniques for managing local remote UE identifier in accordance with aspects of the present disclosure. The device 905 may be an example of aspects of a UE 115 (e.g., a remote UE, a relay UE) as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for managing local remote UE identifier). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for managing local remote UE identifier). In some examples, the transmitter 915 may be co-located with a receiver 910 in a transceiver. The transmitter 915 may utilize a single antenna or a set of multiple antennas.

The communications manager 920, the receiver 910, the transmitter 915, or various combinations thereof or various components thereof may be examples of means for performing various aspects of techniques for managing local remote UE identifier as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a first UE (e.g., the device 905) in accordance with examples as disclosed herein. For example, the communications manager 920 may be configured as or otherwise support a means for transmitting, to a base station, a first uplink message including one or both of a protocol layer source identifier associated with a second UE or a request for a local identifier associated with the second UE. The communications manager 920 may be configured as or otherwise support a means for receiving, from the base station, a first downlink message including a downlink signal radio bearer (DL SRB) message, and the DL SRB message including one or both of the protocol layer source identifier associated with the second UE or the local identifier associated with the second UE in a downlink adaptation layer header of the DL SRB message. The communications manager 920 may be configured as or otherwise support a means for transmitting, to the second UE, in a sidelink adaptation layer header of a sidelink message, the local identifier associated with the second UE based on the received first downlink message.

Additionally or alternatively, the communications manager 920 may support wireless communication at first UE in accordance with examples as disclosed herein. For example, the communications manager 920 may be configured as or otherwise support a means for receiving, from a base station, a first downlink message including a DL SRB message, and the DL SRB message including a local identifier associated with the first UE in a downlink adaptation layer header of the DL SRB message. The communications manager 920 may be configured as or otherwise support a means for determining the local identifier associated with the first UE based on the received first downlink message. The communications manager 920 may be configured as or otherwise support a means for transmitting a first uplink message including an indication of the local identifier associated with the first UE, the first uplink message including an uplink signal radio bearer (UL SRB) message, and the UL SRB message including a sidelink adaptation layer header, the indication of the local identifier associated with the first UE included in the sidelink adaptation layer header.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced power consumption.

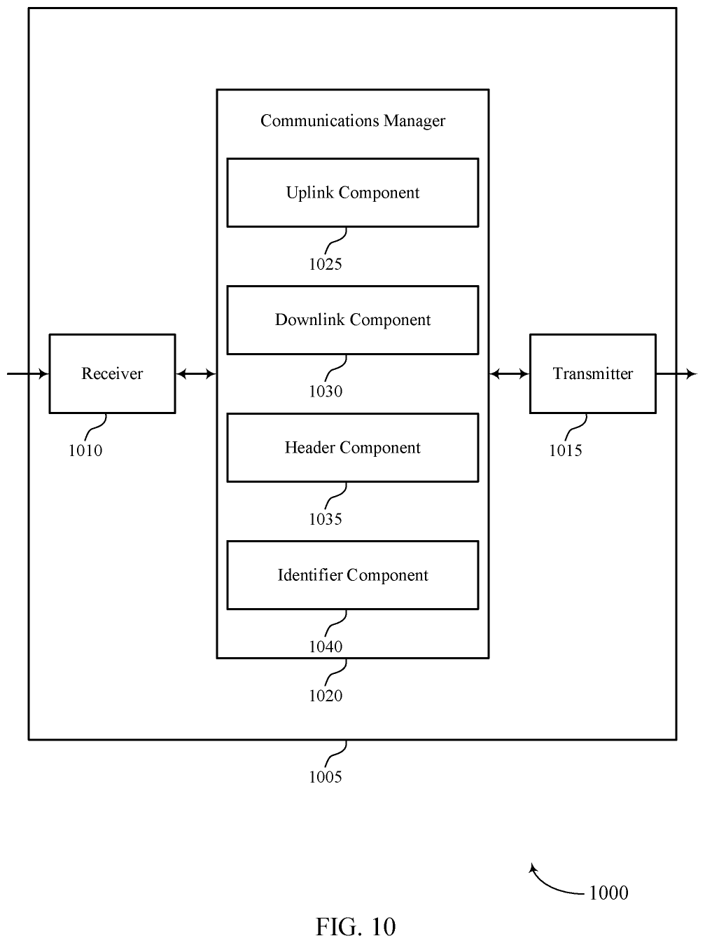

FIG. 10 shows a block diagram 1000 of a device 1005 that supports techniques for managing local remote UE identifier in accordance with aspects of the present disclosure. The device 1005 may be an example of aspects of a device 905 or a UE 115 (e.g., a remote UE, a relay UE) as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for managing local remote UE identifier). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for managing local remote UE identifier). In some examples, the transmitter 1015 may be co-located with a receiver 1010 in a transceiver. The transmitter 1015 may utilize a single antenna or a set of multiple antennas.

The device 1005, or various components thereof, may be an example of means for performing various aspects of techniques for managing local remote UE identifier as described herein. For example, the communications manager 1020 may include an uplink component 1025, a downlink component 1030, a header component 1035, an identifier component 1040, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a first UE (e.g., the device 1005) in accordance with examples as disclosed herein. The uplink component 1025 may be configured as or otherwise support a means for transmitting, to a base station, a first uplink message including one or both of a protocol layer source identifier associated with a second UE or a request for a local identifier associated with the second UE. The downlink component 1030 may be configured as or otherwise support a means for receiving, from the base station, a first downlink message including a DL SRB message, and the DL SRB message including one or both of the protocol layer source identifier associated with the second UE or the local identifier associated with the second UE in a downlink adaptation layer header of the DL SRB message. The header component 1035 may be configured as or otherwise support a means for transmitting, to the second UE, in a sidelink adaptation layer header of a sidelink message, the local identifier associated with the second UE based on the received first downlink message.

Additionally or alternatively, the communications manager 1020 may support wireless communication at first UE (e.g., the device 1005) in accordance with examples as disclosed herein. The downlink component 1030 may be configured as or otherwise support a means for receiving, from a base station, a first downlink message including a DL SRB message, and the DL SRB message including a local identifier associated with the first UE in a downlink adaptation layer header of the DL SRB message. The identifier component 1040 may be configured as or otherwise support a means for determining the local identifier associated with the first UE based on the received first downlink message. The uplink component 1025 may be configured as or otherwise support a means for transmitting a first uplink message including an indication of the local identifier associated with the first UE, the first uplink message including an UL SRB message, and the UL SRB message including a sidelink adaptation layer header, the indication of the local identifier associated with the first UE included in the sidelink adaptation layer header.

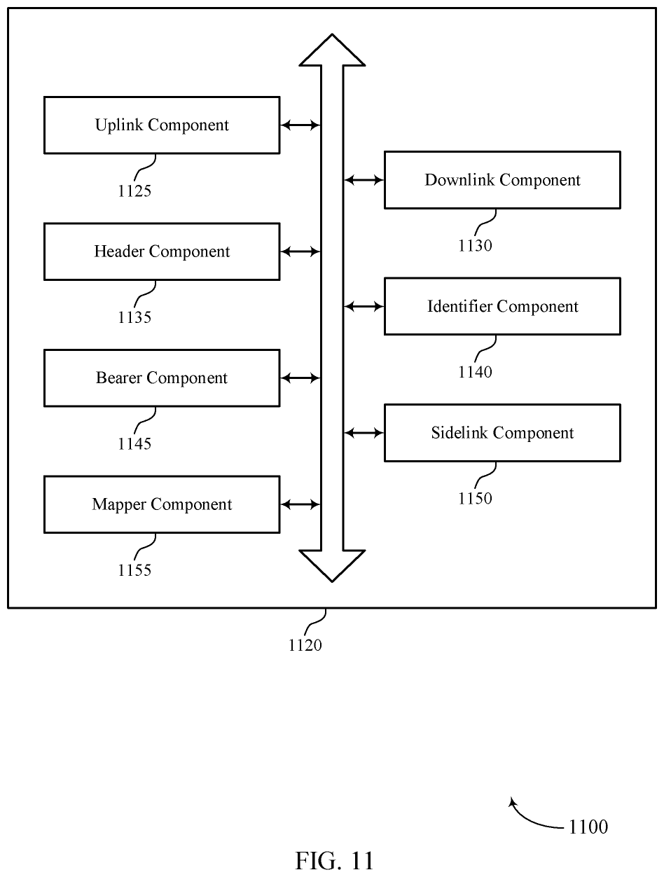

FIG. 11 shows a block diagram 1100 of a communications manager 1120 that supports techniques for managing local remote UE identifier in accordance with aspects of the present disclosure. The communications manager 1120 may be an example of aspects of a communications manager 920, a communications manager 1020, or both, as described herein. The communications manager 1120, or various components thereof, may be an example of means for performing various aspects of techniques for managing local remote UE identifier as described herein. For example, the communications manager 1120 may include an uplink component 1125, a downlink component 1130, a header component 1135, an identifier component 1140, a bearer component 1145, a sidelink component 1150, a mapper component 1155, or any combination thereof. Each of these components may communicate, directly or indirectly, with one another (e.g., via one or more buses).

The communications manager 1120 may support wireless communication at a first UE in accordance with examples as disclosed herein. The uplink component 1125 may be configured as or otherwise support a means for transmitting, to a base station, a first uplink message including one or both of a protocol layer source identifier associated with a second UE or a request for a local identifier associated with the second UE. The downlink component 1130 may be configured as or otherwise support a means for receiving, from the base station, a first downlink message including a DL SRB message, and the DL SRB message including one or both of the protocol layer source identifier associated with the second UE or the local identifier associated with the second UE in a downlink adaptation layer header of the DL SRB message. The header component 1135 may be configured as or otherwise support a means for transmitting, to the second UE, in a sidelink adaptation layer header of a sidelink message, the local identifier associated with the second UE based on the received first downlink message.

In some examples, the downlink component 1130 may be configured as or otherwise support a means for receiving, from the base station, a second downlink message including an indication of a mapping between the protocol layer source identifier associated with the second UE and the local identifier associated with the second UE, where the second downlink message includes an RRC reconfiguration. In some examples, the uplink component 1125 may be configured as or otherwise support a means for transmitting, to the base station, a second uplink message based on the received second downlink message, the second uplink message including an RRC reconfiguration complete.

In some examples, the mapper component 1155 may be configured as or otherwise support a means for determining the mapping between the protocol layer source identifier associated with the second UE and the local identifier associated with the second UE based on the received second downlink message. In some examples, the mapper component 1155 may be configured as or otherwise support a means for storing the determined mapping between the protocol layer source identifier associated with the second UE and the local identifier associated with the second UE. In some examples, the uplink component 1125 may be configured as or otherwise support a means for transmitting, to the base station, the second uplink message is based on storing the determined mapping between the protocol layer source identifier associated with the second UE and the local identifier associated with the second UE. In some examples, the RRC reconfiguration complete includes the local identifier associated with the second UE in an uplink adaptation layer header of the RRC reconfiguration complete.

In some examples, the header component 1135 may be configured as or otherwise support a means for including, in an uplink adaptation layer header of the first uplink message, the indication of the local identifier associated with the second UE, the first uplink message including an UL SRB message associated with the second UE. In some examples, the downlink adaptation layer header of the first downlink message includes an indication of a mapping between the protocol layer source identifier associated with the second UE and the local identifier associated with the second UE. In some examples, the downlink adaptation layer header of the first downlink message includes or excludes the local identifier associated with the second UE.

In some examples, the bearer component 1145 may be configured as or otherwise support a means for configuring a sidelink bearer associated with a sidelink between the first UE and the second UE based on the local identifier associated with the second UE, the sidelink bearer including a sidelink radio link control bearer. In some examples, the uplink component 1125 may be configured as or otherwise support a means for transmitting, to the base station, a second uplink message based on configuring the sidelink bearer associated with the sidelink, the second uplink message including an UL SRB message, and the UL SRB message including the local identifier associated with the second UE in an uplink adaptation layer header of the UL SRB message.

In some examples, the uplink component 1125 may be configured as or otherwise support a means for receiving, from the second UE, a second uplink message the second uplink message including an UL SRB message. In some examples, the identifier component 1140 may be configured as or otherwise support a means for generating a random local identifier associated with the second UE based on the received second uplink message. In some examples, the uplink component 1125 may be configured as or otherwise support a means for transmitting, to the base station, a third uplink message, the third uplink message including the UL SRB message, and the UL SRB message including the generated random local identifier associated with the second UE in an uplink adaptation layer header of the third uplink message.

In some examples, the mapper component 1155 may be configured as or otherwise support a means for receiving, from the base station, an indication of a mapping between the local identifier associated with the second UE and a C-RNTI associated with the second UE, where the DL SRB message includes the local identifier associated with the second UE in the downlink adaptation layer header of the DL SRB message. In some examples, the sidelink component 1150 may be configured as or otherwise support a means for receiving, from the second UE, a sidelink message including an indication of the local identifier associated with the second UE included in a sidelink adaptation layer header of the sidelink message. In some examples, the mapper component 1155 may be configured as or otherwise support a means for determining a mapping between the local identifier associated with the second UE and the protocol layer source identifier associated with the second UE based on one or both of the received sidelink message or the second uplink message.

In some examples, the uplink component 1125 may be configured as or otherwise support a means for including, in the first uplink message, the indication of the local identifier associated with the second UE in an uplink adaptation layer header of the first uplink message based on the determined mapping between the local identifier associated with the second UE and the protocol layer source identifier associated with the second UE. In some examples, the downlink component 1130 may be configured as or otherwise support a means for receiving, from the base station, a second downlink message including one or both of a random generated local identifier associated with the second UE or the local identifier associated with the second UE, the second downlink message including an RRC reconfiguration.

In some examples, the sidelink component 1150 may be configured as or otherwise support a means for receiving, from the second UE, a sidelink message including an indication of the local identifier associated with the second UE, the sidelink message including a PC5 RRC message. In some examples, receiving, from the base station, the first downlink message is based on the first UE operating in a connected mode, the first downlink message including a handover message.

In some examples, the sidelink component 1150 may be configured as or otherwise support a means for establishing a sidelink between the first UE and the second UE in a connected mode based on receiving a second downlink message, the second downlink message including an RRC reconfiguration, and the RRC reconfiguration includes a protocol layer identifier associated with the first UE. In some examples, the sidelink component 1150 may be configured as or otherwise support a means for transmitting, to the second UE, a second sidelink message based on the sidelink bearer configuration from the base station, the second sidelink message including the local identifier associated with the second UE in a sidelink adaptation layer header of the second sidelink message.

In some examples, the sidelink component 1150 may be configured as or otherwise support a means for establishing a sidelink between the first UE and the second UE in an idle or inactive mode based on receiving a second downlink message, the second downlink message including an RRC reconfiguration, and the RRC reconfiguration include a protocol layer identifier associated with the first UE. In some examples, the sidelink component 1150 may be configured as or otherwise support a means for transmitting, to the second UE, a second sidelink message based on a default sidelink bearer configuration, the second sidelink message including the local identifier associated with the second UE in a sidelink adaptation layer header of the second sidelink message.

In some examples, the identifier component 1140 may be configured as or otherwise support a means for receiving an indication of one or both of the local identifier associated with the second UE or an updated local identifier associated with the second UE. In some examples, the identifier component 1140 may be configured as or otherwise support a means for updating a local identifier associated with the second UE based on the received indication. In some examples, the identifier component 1140 may be configured as or otherwise support a means for transmitting, to the first UE, or receiving, from the first UE, the updated local identifier associated with the second UE. In some examples, the updated local identifier associated with the second UE is included in one or more of an uplink adaptation layer header, or the downlink adaptation layer header, or the sidelink adaptation layer.

Additionally or alternatively, the communications manager 1120 may support wireless communication at first UE in accordance with examples as disclosed herein. In some examples, the downlink component 1130 may be configured as or otherwise support a means for receiving, from a base station, a first downlink message including a DL SRB message, and the DL SRB message including a local identifier associated with the first UE in a downlink adaptation layer header of the DL SRB message. The identifier component 1140 may be configured as or otherwise support a means for determining the local identifier associated with the first UE based on the received first downlink message. In some examples, the uplink component 1125 may be configured as or otherwise support a means for transmitting a first uplink message including an indication of the local identifier associated with the first UE, the first uplink message including an UL SRB message, and the UL SRB message including a sidelink adaptation layer header, the indication of the local identifier associated with the first UE included in the sidelink adaptation layer header.

In some examples, the sidelink component 1150 may be configured as or otherwise support a means for transmitting, to the second UE, a sidelink message including the indication of the local identifier associated with the first UE included in the sidelink adaptation layer header. In some examples, the sidelink component 1150 may be configured as or otherwise support a means for transmitting, to the second UE, a sidelink message including an indication of the local identifier associated with the first UE, the sidelink message including a sidelink RRC message.

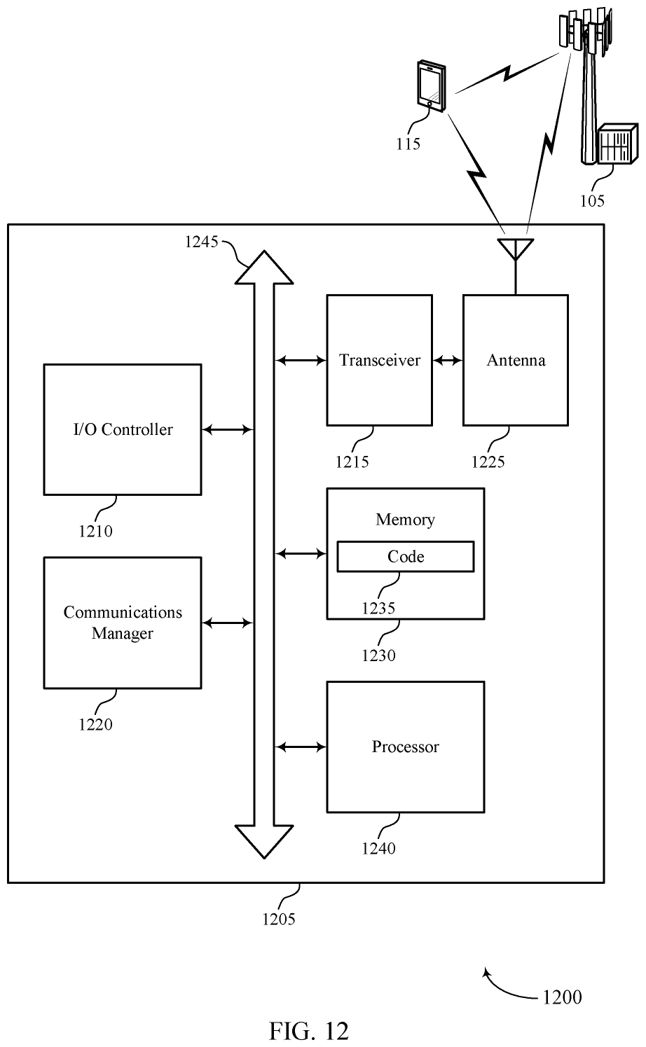

FIG. 12 shows a diagram of a system 1200 including a device 1205 that supports techniques for managing local remote UE identifier in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for managing local remote UE identifier). For example, the device 1205 or a component of the device 1205 may include a processor 1240 and memory 1230 coupled to the processor 1240, the processor 1240 and memory 1230 configured to perform various functions described herein.

The communications manager 1220 may support wireless communication at a first UE (e.g., the device 1205) in accordance with examples as disclosed herein. For example, the communications manager 1220 may be configured as or otherwise support a means for transmitting, to a base station, a first uplink message including one or both of a protocol layer source identifier associated with a second UE or a request for a local identifier associated with the second UE. The communications manager 1220 may be configured as or otherwise support a means for receiving, from the base station, a first downlink message including a DL SRB message, and the DL SRB message including one or both of the protocol layer source identifier associated with the second UE or the local identifier associated with the second UE in a downlink adaptation layer header of the DL SRB message. The communications manager 1220 may be configured as or otherwise support a means for transmitting, to the second UE, in a sidelink adaptation layer header of a sidelink message, the local identifier associated with the second UE based on the received first downlink message.

Additionally or alternatively, the communications manager 1220 may support wireless communication at first UE (e.g., the device 1205) in accordance with examples as disclosed herein. For example, the communications manager 1220 may be configured as or otherwise support a means for receiving, from a base station, a first downlink message including a DL SRB message, and the DL SRB message including a local identifier associated with the first UE in a downlink adaptation layer header of the DL SRB message. The communications manager 1220 may be configured as or otherwise support a means for determining the local identifier associated with the first UE based on the received first downlink message. The communications manager 1220 may be configured as or otherwise support a means for transmitting a first uplink message including an indication of the local identifier associated with the first UE, the first uplink message including an UL SRB message, and the UL SRB message including a sidelink adaptation layer header, the indication of the local identifier associated with the first UE included in the sidelink adaptation layer header.

By including or configuring the communications manager 1220 in accordance with examples as described herein, the device 1205 may support techniques for improved communication reliability, reduced latency, and more efficient utilization of communication resources.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for managing local remote UE identifier as described herein, or the processor 1240 and the memory 1230 may be otherwise configured to perform or support such operations.

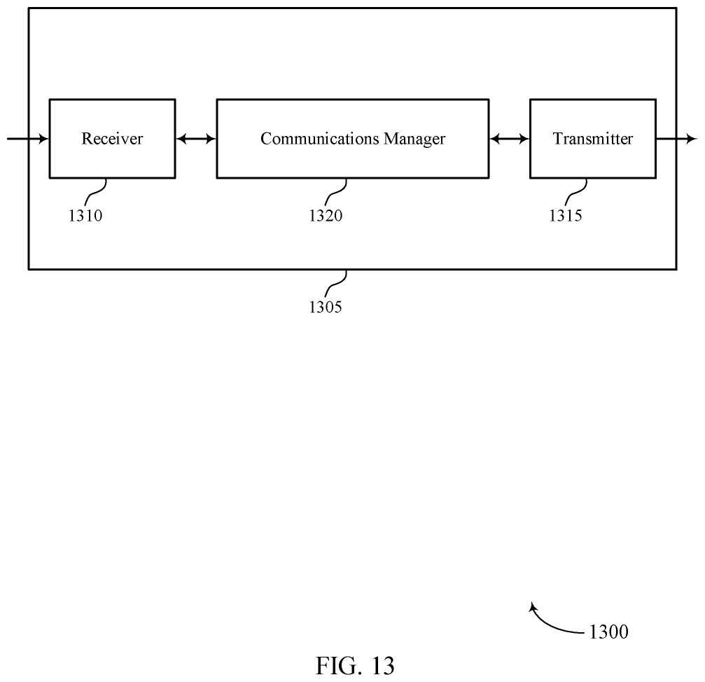

FIG. 13 shows a block diagram 1300 of a device 1305 that supports techniques for managing local remote UE identifier in accordance with aspects of the present disclosure. The device 1305 may be an example of aspects of a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to techniques for managing local remote UE identifier). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to techniques for managing local remote UE identifier). In some examples, the transmitter 1315 may be co-located with a receiver 1310 in a transceiver. The transmitter 1315 may utilize a single antenna or a set of multiple antennas.

The communications manager 1320, the receiver 1310, the transmitter 1315, or various combinations thereof or various components thereof may be examples of means for performing various aspects of techniques for managing local remote UE identifier as described herein. For example, the communications manager 1320, the receiver 1310, the transmitter 1315, or various combinations or components thereof may support a method for performing one or more of the functions described herein.

In some examples, the communications manager 1320, the receiver 1310, the transmitter 1315, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1320, the receiver 1310, the transmitter 1315, or various combinations or components thereof may be implemented in code (e.g., as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1320 may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a base station (e.g., the device 1305) in accordance with examples as disclosed herein. For example, the communications manager 1320 may be configured as or otherwise support a means for receiving, from a first UE, a first uplink message including one or both of a protocol layer source identifier associated with a second UE or a request for a local identifier associated with the second UE. The communications manager 1320 may be configured as or otherwise support a means for assigning the local identifier associated with the second UE based on the received first uplink message. The communications manager 1320 may be configured as or otherwise support a means for transmitting, to the second UE, a first downlink message indicating the assigned local identifier associated with the second UE.

By including or configuring the communications manager 1320 in accordance with examples as described herein, the device 1305 (e.g., a processor controlling or otherwise coupled to the receiver 1310, the transmitter 1315, the communications manager 1320, or a combination thereof) may support techniques for more efficient utilization of communication resources.

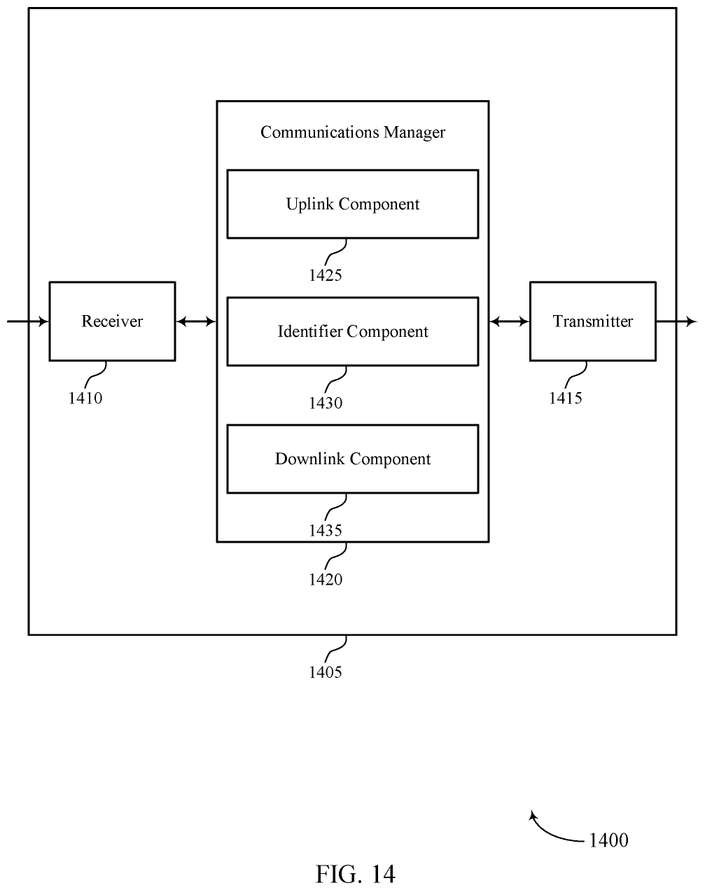

FIG. 14 shows a block diagram 1400 of a device 1405 that supports techniques for managing local remote UE identifier in accordance with aspects of the present disclosure. The device 1405 may be an example of aspects of a device 1305 or a base station 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for receiving information such as packets, user data, control information, or any combination thereof associated with various information channels (e.g., control channels, data channels, information channels related to techniques for managing local remote UE identifier). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (e.g., control channels, data channels, information channels related to techniques for managing local remote UE identifier). In some examples, the transmitter 1415 may be co-located with a receiver 1410 in a transceiver. The transmitter 1415 may utilize a single antenna or a set of multiple antennas.

The device 1405, or various components thereof, may be an example of means for performing various aspects of techniques for managing local remote UE identifier as described herein. For example, the communications manager 1420 may include an uplink component 1425, an identifier component 1430, a downlink component 1435, or any combination thereof. The communications manager 1420 may be an example of aspects of a communications manager 1320 as described herein. In some examples, the communications manager 1420, or various components thereof, may be configured to perform various operations (e.g., receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communication at a base station (e.g., the device 1405) in accordance with examples as disclosed herein. The uplink component 1425 may be configured as or otherwise support a means for receiving, from a first UE, a first uplink message including one or both of a protocol layer source identifier associated with a second UE or a request for a local identifier associated with the second UE. The identifier component 1430 may be configured as or otherwise support a means for assigning the local identifier associated with the second UE based on the received first uplink message. The downlink component 1435 may be configured as or otherwise support a means for transmitting, to the second UE, a first downlink message indicating the assigned local identifier associated with the second UE.

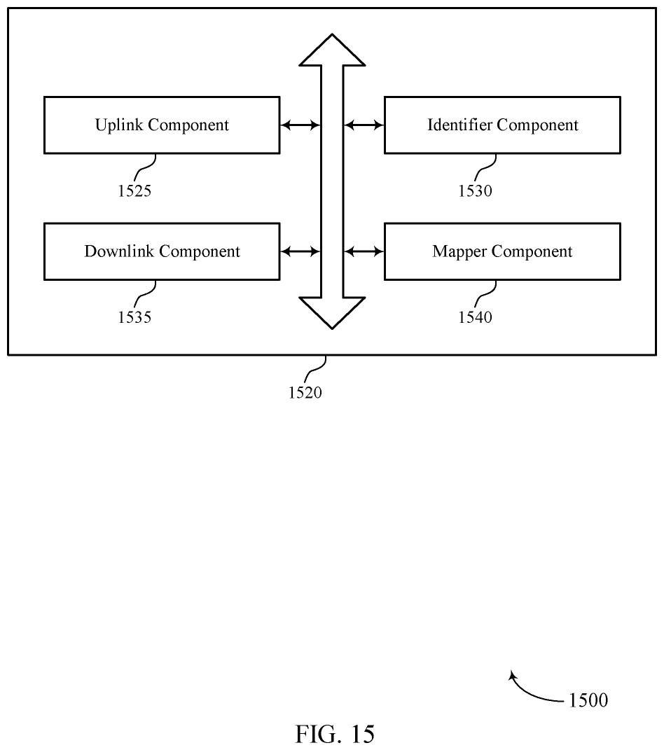

FIG. 15 shows a block diagram 1500 of a communications manager 1520 that supports techniques for managing local remote UE identifier in accordance with aspects of the present disclosure. The communications manager 1520 may be an example of aspects of a communications manager 1320, a communications manager 1420, or both, as described herein. The communications manager 1520, or various components thereof, may be an example of means for performing various aspects of techniques for managing local remote UE identifier as described herein. For example, the communications manager 1520 may include an uplink component 1525, an identifier component 1530, a downlink component 1535, a mapper component 1540, or any combination thereof. Each of these components may communicate, directly or indirectly, with one another (e.g., via one or more buses).

The communications manager 1520 may support wireless communication at a base station in accordance with examples as disclosed herein. The uplink component 1525 may be configured as or otherwise support a means for receiving, from a first UE, a first uplink message including one or both of a protocol layer source identifier associated with a second UE or a request for a local identifier associated with the second UE. The identifier component 1530 may be configured as or otherwise support a means for assigning the local identifier associated with the second UE based on the received first uplink message. The downlink component 1535 may be configured as or otherwise support a means for transmitting, to the second UE, a first downlink message indicating the assigned local identifier associated with the second UE.

In some examples, the mapper component 1540 may be configured as or otherwise support a means for determining a mapping between the protocol layer source identifier associated with the second UE and the local identifier associated with the second UE based on the received first uplink message. In some examples, the downlink component 1535 may be configured as or otherwise support a means for transmitting, to the first UE, the first downlink message including an indication of the mapping between the protocol layer source identifier associated with the second UE and the local identifier associated with the second UE, where the first downlink message includes an RRC reconfiguration. In some examples, the uplink component 1525 may be configured as or otherwise support a means for receiving, from the first UE, a second uplink message based on the transmitted first downlink message, the second uplink message including an RRC reconfiguration complete. In some examples, the RRC reconfiguration includes one or both local identifiers associated with the second UE or a protocol layer identifier associated with the first UE.

In some examples, the uplink component 1525 may be configured as or otherwise support a means for receiving, from the first UE, a second uplink message based on the transmitted first downlink message, the second uplink message including an UL SRB message, and the UL SRB message including the local identifier associated with the second UE in an uplink adaptation layer header of the UL SRB message. In some examples, the first downlink message includes a DL SRB message, and the DL SRB message including the local identifier associated with the second UE in a downlink adaptation layer header of the DL SRB message.

In some examples, the uplink component 1525 may be configured as or otherwise support a means for receiving, from the first UE, a second uplink message, the second uplink message including an UL SRB message, and the UL SRB message including a generated random local identifier associated with the second UE. In some examples, the mapper component 1540 may be configured as or otherwise support a means for determining a mapping between the local identifier associated with the second UE and a C-RNTI associated with the second UE based on the received second uplink message. In some examples, the mapper component 1540 may be configured as or otherwise support a means for transmitting, to the first UE, an indication of the mapping between the local identifier associated with the second UE and the C-RNTI associated with the second UE in the first downlink message, the first downlink message including a DL SRB message, and the DL SRB message including the local identifier associated with the second UE in a downlink adaptation layer header of the DL SRB message.

In some examples, the downlink component 1535 may be configured as or otherwise support a means for transmitting, to the first UE, a second downlink message including one or both of a random generated local identifier associated with the second UE or the local identifier associated with the second UE. In some examples, the identifier component 1530 may be configured as or otherwise support a means for updating the local identifier associated with the second UE. In some examples, the identifier component 1530 may be configured as or otherwise support a means for transmitting, to one or both of the first UE or the second UE, an indication of the local identifier associated with the second UE, the updated local identifier associated with the second UE, or an updated local identifier associated with the first UE.

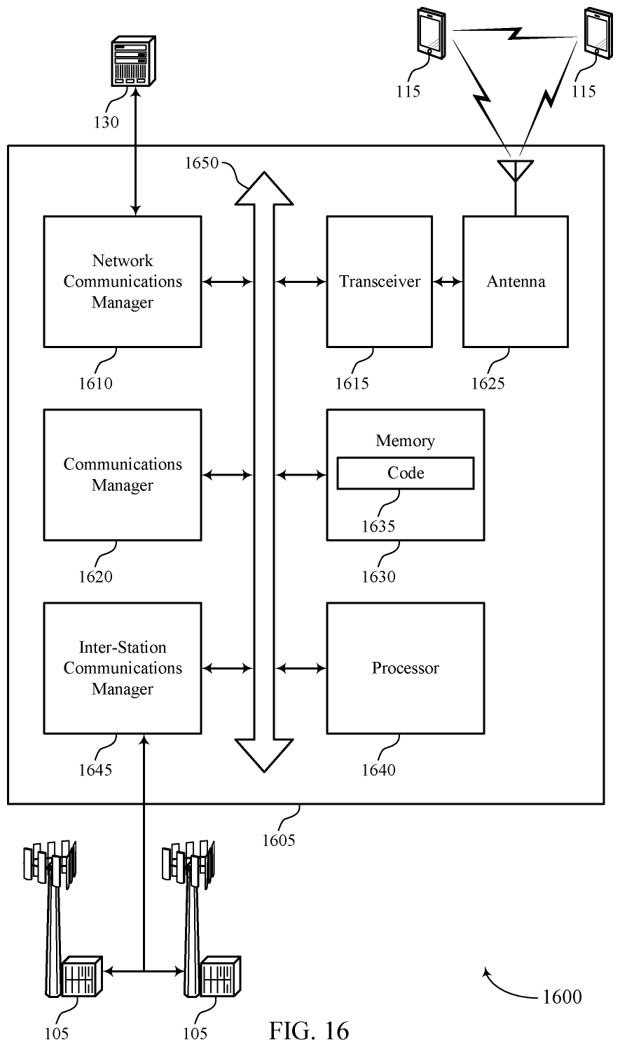

FIG. 16 shows a diagram of a system 1600 including a device 1605 that supports techniques for managing local remote UE identifier in accordance with aspects of the present disclosure. The device 1605 may be an example of or include the components of a device 1305, a device 1405, or a base station 105 as described herein. The device 1605 may communicate wirelessly with one or more base stations 105, UEs 115, or any combination thereof. The device 1605 may include components for bi-directional voice and data communications including components for transmitting and receiving communications, such as a communications manager 1620, a network communications manager 1610, a transceiver 1615, an antenna 1625, a memory 1630, code 1635, a processor 1640, and an inter-station communications manager 1645. These components may be in electronic communication or otherwise coupled (e.g., operatively, communicatively, functionally, electronically, electrically) via one or more buses (e.g., a bus 1650).

The network communications manager 1610 may manage communications with a core network 130 (e.g., via one or more wired backhaul links). For example, the network communications manager 1610 may manage the transfer of data communications for client devices, such as one or more UEs 115.

In some cases, the device 1605 may include a single antenna 1625. However, in some other cases the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include RAM and ROM. The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (e.g., when compiled and executed) to perform functions described herein. In some cases, the memory 1630 may contain, among other things, a BIOS which may control basic hardware or software operation such as the interaction with peripheral components or devices.

The processor 1640 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (e.g., the memory 1630) to cause the device 1605 to perform various functions (e.g., functions or tasks supporting techniques for managing local remote UE identifier). For example, the device 1605 or a component of the device 1605 may include a processor 1640 and memory 1630 coupled to the processor 1640, the processor 1640 and memory 1630 configured to perform various functions described herein.

The inter-station communications manager 1645 may manage communications with other base stations 105, and may include a controller or scheduler for controlling communications with UEs 115 in cooperation with other base stations 105. For example, the inter-station communications manager 1645 may coordinate scheduling for transmissions to UEs 115 for various interference mitigation techniques such as beamforming or joint transmission. In some examples, the inter-station communications manager 1645 may provide an X2 interface within an LTE/LTE-A wireless communications network technology to provide communication between base stations 105.

The communications manager 1620 may support wireless communication at a base station (e.g., the device 1605) in accordance with examples as disclosed herein. For example, the communications manager 1620 may be configured as or otherwise support a means for receiving, from a first UE, a first uplink message including one or both of a protocol layer source identifier associated with a second UE or a request for a local identifier associated with the second UE. The communications manager 1620 may be configured as or otherwise support a means for assigning the local identifier associated with the second UE based on the received first uplink message. The communications manager 1620 may be configured as or otherwise support a means for transmitting, to the second UE, a first downlink message indicating the assigned local identifier associated with the second UE. By including or configuring the communications manager 1620 in accordance with examples as described herein, the device 1605 may support techniques for reduced power consumption.

In some examples, the communications manager 1620 may be configured to perform various operations (e.g., receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of techniques for managing local remote UE identifier as described herein, or the processor 1640 and the memory 1630 may be otherwise configured to perform or support such operations.

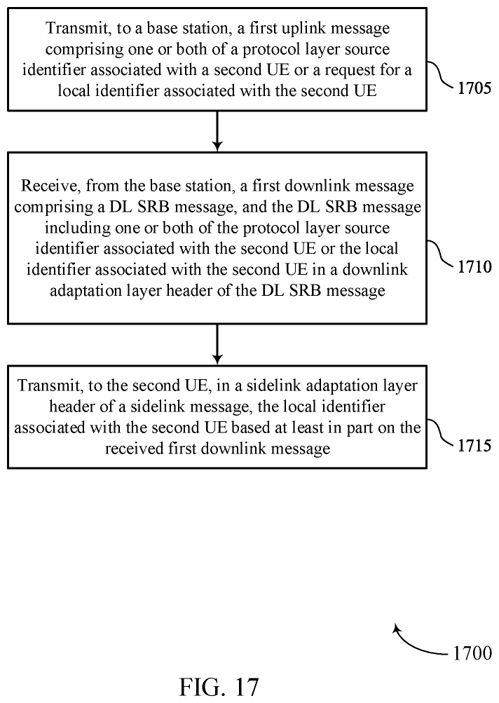

FIG. 17 shows a flowchart illustrating a method 1700 that supports techniques for managing local remote UE identifier in accordance with aspects of the present disclosure. The operations of the method 1700 may be implemented by a UE or its components as described herein. For example, the operations of the method 1700 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1705, the method may include transmitting, to a base station, a first uplink message including one or both of a protocol layer source identifier associated with a second UE or a request for a local identifier associated with the second UE. The operations of 1705 may be performed in accordance with examples as disclosed herein. In some examples, aspects of the operations of 1705 may be performed by an uplink component 1125 as described with reference to FIG. 11.

At 1710, the method may include receiving, from the base station, a first downlink message including a DL SRB message, and the DL SRB message including one or both of the protocol layer source identifier associated with the second UE or the local identifier associated with the second UE in a downlink adaptation layer header of the DL SRB message. The operations of 1710 may be performed in accordance with examples as disclosed herein. In some examples, aspects of the operations of 1710 may be performed by a downlink component 1130 as described with reference to FIG. 11.

At 1715, the method may include transmitting, to the second UE, in a sidelink adaptation layer header of a sidelink message, the local identifier associated with the second UE based on the received first downlink message. The operations of 1715 may be performed in accordance with examples as disclosed herein. In some examples, aspects of the operations of 1715 may be performed by a header component 1135 as described with reference to FIG. 11.

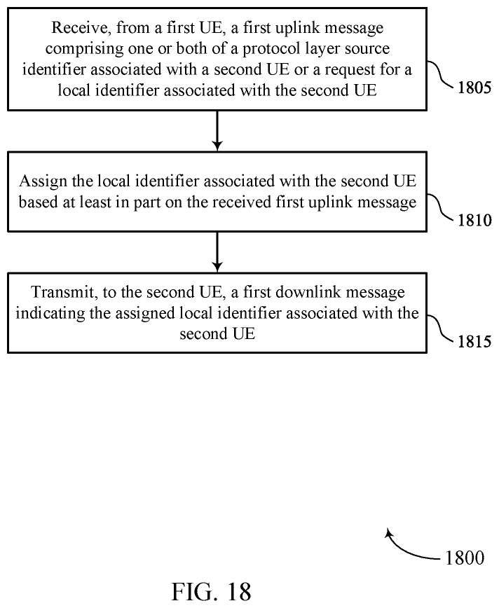

FIG. 18 shows a flowchart illustrating a method 1800 that supports techniques for managing local remote UE identifier in accordance with aspects of the present disclosure. The operations of the method 1800 may be implemented by a base station or its components as described herein. For example, the operations of the method 1800 may be performed by a base station 105 as described with reference to FIGS. 1 through 8 and 13 through 16. In some examples, a base station may execute a set of instructions to control the functional elements of the base station to perform the described functions. Additionally or alternatively, the base station may perform aspects of the described functions using special-purpose hardware.

At 1805, the method may include receiving, from a first UE, a first uplink message including one or both of a protocol layer source identifier associated with a second UE or a request for a local identifier associated with the second UE. The operations of 1805 may be performed in accordance with examples as disclosed herein. In some examples, aspects of the operations of 1805 may be performed by an uplink component 1525 as described with reference to FIG. 15.

At 1810, the method may include assigning the local identifier associated with the second UE based on the received first uplink message. The operations of 1810 may be performed in accordance with examples as disclosed herein. In some examples, aspects of the operations of 1810 may be performed by an identifier component 1530 as described with reference to FIG. 15.

At 1815, the method may include transmitting, to the second UE, a first downlink message indicating the assigned local identifier associated with the second UE. The operations of 1815 may be performed in accordance with examples as disclosed herein. In some examples, aspects of the operations of 1815 may be performed by a downlink component 1535 as described with reference to FIG. 15.

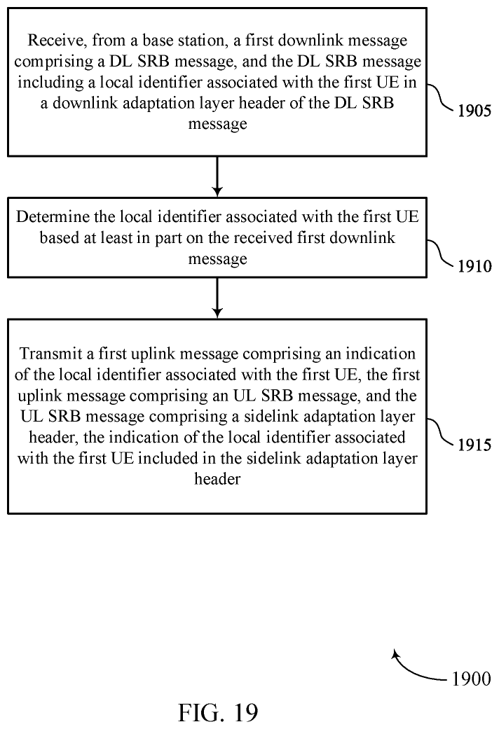

FIG. 19 shows a flowchart illustrating a method 1900 that supports techniques for managing local remote UE identifier in accordance with aspects of the present disclosure. The operations of the method 1900 may be implemented by a UE or its components as described herein. For example, the operations of the method 1900 may be performed by a UE 115 as described with reference to FIGS. 1 through 12. In some examples, a UE may execute a set of instructions to control the functional elements of the UE to perform the described functions. Additionally or alternatively, the UE may perform aspects of the described functions using special-purpose hardware.

At 1905, the method may include receiving, from a base station, a first downlink message including a DL SRB message, and the DL SRB message including a local identifier associated with the first UE in a downlink adaptation layer header of the DL SRB message. The operations of 1905 may be performed in accordance with examples as disclosed herein. In some examples, aspects of the operations of 1905 may be performed by a downlink component 1130 as described with reference to FIG. 11.

At 1910, the method may include determining the local identifier associated with the first UE based on the received first downlink message. The operations of 1910 may be performed in accordance with examples as disclosed herein. In some examples, aspects of the operations of 1910 may be performed by an identifier component 1140 as described with reference to FIG. 11.

At 1915, the method may include transmitting a first uplink message including an indication of the local identifier associated with the first UE, the first uplink message including an UL SRB message, and the UL SRB message including a sidelink adaptation layer header, the indication of the local identifier associated with the first UE included in the sidelink adaptation layer header. The operations of 1915 may be performed in accordance with examples as disclosed herein. In some examples, aspects of the operations of 1915 may be performed by an uplink component 1125 as described with reference to FIG. 11.

The following provides an overview of aspects of the present disclosure:

Aspect 1: A method for wireless communication at a first UE, comprising: transmitting, to a base station, a first uplink message comprising one or both of a protocol layer source identifier associated with a second UE or a request for a local identifier associated with the second UE; receiving, from the base station, a first downlink message comprising a DL SRB message, and the DL SRB message including one or both of the protocol layer source identifier associated with the second UE or the local identifier associated with the second UE in a downlink adaptation layer header of the DL SRB message; and transmitting, to the second UE, in a sidelink adaptation layer header of a sidelink message, the local identifier associated with the second UE based at least in part on the received first downlink message.

Aspect 2: The method of aspect 1, further comprising: receiving, from the base station, a second downlink message comprising an indication of a mapping between the protocol layer source identifier associated with the second UE and the local identifier associated with the second UE, wherein the second downlink message comprises an RRC reconfiguration; and transmitting, to the base station, a second uplink message based at least in part on the received second downlink message, the second uplink message comprising an RRC reconfiguration complete.

Aspect 3: The method of aspect 2, further comprising: determining the mapping between the protocol layer source identifier associated with the second UE and the local identifier associated with the second UE based at least in part on the received second downlink message; and storing the determined mapping between the protocol layer source identifier associated with the second UE and the local identifier associated with the second UE, wherein transmitting, to the base station, the second uplink message is based at least in part on storing the determined mapping between the protocol layer source identifier associated with the second UE and the local identifier associated with the second UE.

Aspect 4: The method of any of aspects 2 through 3, wherein the RRC reconfiguration complete comprises the local identifier associated with the second UE in an uplink adaptation layer header of the RRC reconfiguration complete.

Aspect 5: The method of any of aspects 1 through 4, further comprising: including, in an uplink adaptation layer header of the first uplink message, the indication of the local identifier associated with the second UE, the first uplink message comprising an UL SRB message associated with the second UE.

Aspect 6: The method of any of aspects 1 through 5, wherein the downlink adaptation layer header of the first downlink message comprises an indication of a mapping between the protocol layer source identifier associated with the second UE and the local identifier associated with the second UE, and the downlink adaptation layer header of the first downlink message includes or excludes the local identifier associated with the second UE.

Aspect 7: The method of any of aspects 1 through 6, further comprising: configuring a sidelink bearer associated with a sidelink between the first UE and the second UE based at least in part on the local identifier associated with the second UE, the sidelink bearer comprising a sidelink radio link control bearer; and transmitting, to the base station, a second uplink message based at least in part on configuring the sidelink bearer associated with the sidelink, the second uplink message comprising an UL SRB message, and the UL SRB message including the local identifier associated with the second UE in an uplink adaptation layer header of the UL SRB message.

Aspect 8: The method of any of aspects 1 through 7, further comprising: receiving, from the second UE, a second uplink message the second uplink message comprising an UL SRB message; generating a random local identifier associated with the second UE based at least in part on the received second uplink message; and transmitting, to the base station, a third uplink message, the third uplink message comprising the UL SRB message, and the UL SRB message including the generated random local identifier associated with the second UE in an uplink adaptation layer header of the third uplink message.

Aspect 9: The method of aspect 8, further comprising: receiving, from the base station, an indication of a mapping between the local identifier associated with the second UE and a C-RNTI associated with the second UE, wherein the DL SRB message includes the local identifier associated with the second UE in the downlink adaptation layer header of the DL SRB message.

Aspect 10: The method of any of aspects 1 through 9, further comprising: receiving, from the second UE, a sidelink message comprising an indication of the local identifier associated with the second UE included in a sidelink adaptation layer header of the sidelink message; determining a mapping between the local identifier associated with the second UE and the protocol layer source identifier associated with the second UE based at least in part on one or both of the received sidelink message or the second uplink message

Aspect 11: The method of aspect 10, further comprising: including, in the first uplink message, the indication of the local identifier associated with the second UE in an uplink adaptation layer header of the first uplink message based at least in part on the determined mapping between the local identifier associated with the second UE and the protocol layer source identifier associated with the second UE.

Aspect 12: The method of any of aspects 1 through 11, further comprising: receiving, from the base station, a second downlink message comprising one or both of a random generated local identifier associated with the second UE or the local identifier associated with the second UE, the second downlink message comprising an RRC reconfiguration.

Aspect 13: The method of any of aspects 1 through 12, further comprising: receiving, from the second UE, a sidelink message comprising an indication of the local identifier associated with the second UE, the sidelink message comprising a PC5 RRC message.

Aspect 14: The method of any of aspects 1 through 13, wherein receiving, from the base station, the first downlink message is based at least in part on the first UE operating in a connected mode, the first downlink message comprising a handover message.

Aspect 15: The method of any of aspects 1 through 14, further comprising: establishing a sidelink between the first UE and the second UE based at least in part on receiving a second downlink message, the second downlink message comprising an RRC reconfiguration, and the RRC reconfiguration comprises a protocol layer identifier associated with the first UE; and transmitting, to the second UE, a second sidelink message based at least in part on the established sidelink, the second sidelink message including the local identifier associated with the second UE in a sidelink adaptation layer header of the second sidelink message.

Aspect 16: The method of any of aspects 1 through 15, further comprising: receiving an indication of one or both of the local identifier associated with the second UE or an updated local identifier associated with the second UE; updating a local identifier associated with the second UE based at least in part on the received indication; and transmitting, to the first UE, or receiving, from the first UE, the updated local identifier associated with the second UE.

Aspect 17: The method of aspect 16, wherein the updated local identifier associated with the second UE is included in one or more of an uplink adaptation layer header, or the downlink adaptation layer header, or the sidelink adaptation layer.

Aspect 18: A method for wireless communication at a base station, comprising: receiving, from a first UE, a first uplink message comprising one or both of a protocol layer source identifier associated with a second UE or a request for a local identifier associated with the second UE; assigning the local identifier associated with the second UE based at least in part on the received first uplink message; and transmitting, to the second UE, a first downlink message indicating the assigned local identifier associated with the second UE.

Aspect 19: The method of aspect 18, further comprising: determining a mapping between the protocol layer source identifier associated with the second UE and the local identifier associated with the second UE based at least in part on the received first uplink message; transmitting, to the first UE, the first downlink message comprising an indication of the mapping between the protocol layer source identifier associated with the second UE and the local identifier associated with the second UE, wherein the first downlink message comprises an RRC reconfiguration; and receiving, from the first UE, a second uplink message based at least in part on the transmitted first downlink message, the second uplink message comprising an RRC reconfiguration complete.

Aspect 20: The method of aspect 19, wherein the RRC reconfiguration comprises one or both of the local identifier associated with the second UE or a protocol layer identifier associated with the first UE.

Aspect 21: The method of any of aspects 19 through 20, further comprising: receiving, from the first UE, a second uplink message based at least in part on the transmitted first downlink message, the second uplink message comprising an UL SRB message, and the UL SRB message including the local identifier associated with the second UE in an uplink adaptation layer header of the UL SRB message.

Aspect 22: The method of any of aspects 18 through 21, wherein the first downlink message comprises a DL SRB message, and the DL SRB message including the local identifier associated with the second UE in a downlink adaptation layer header of the DL SRB message.

Aspect 23: The method of any of aspects 18 through 22, further comprising: receiving, from the first UE, a second uplink message, the second uplink message comprising an UL SRB message, and the UL SRB message including a generated random local identifier associated with the second UE.

Aspect 24: The method of aspect 23, further comprising: determining a mapping between the local identifier associated with the second UE and a C-RNTI associated with the second UE based at least in part on the received second uplink message; and transmitting, to the first UE, an indication of the mapping between the local identifier associated with the second UE and the C-RNTI associated with the second UE in the first downlink message, the first downlink message comprising a DL SRB message, and the DL SRB message including the local identifier associated with the second UE in a downlink adaptation layer header of the DL SRB message.

Aspect 25: The method of any of aspects 18 through 24, further comprising: transmitting, to the first UE, a second downlink message comprising one or both of a random generated local identifier associated with the second UE or the local identifier associated with the second UE.

Aspect 26: The method of any of aspects 18 through 25, further comprising: updating the local identifier associated with the second UE; and transmitting, to one or both of the first UE or the second UE, an indication of the local identifier associated with the second UE, the updated local identifier associated with the second UE, or an updated local identifier associated with the first UE.

Aspect 27: A method for wireless communication at first UE, comprising: receiving, from a base station, a first downlink message comprising a DL SRB message, and the DL SRB message including a local identifier associated with the first UE in a downlink adaptation layer header of the DL SRB message; and determining the local identifier associated with the first UE based at least in part on the received first downlink message; and transmitting a first uplink message comprising an indication of the local identifier associated with the first UE, the first uplink message comprising an UL SRB message, and the UL SRB message comprising a sidelink adaptation layer header, the indication of the local identifier associated with the first UE included in the sidelink adaptation layer header.

Aspect 28: The method of aspect 27, further comprising: transmitting, to the second UE, a sidelink message comprising the indication of the local identifier associated with the first UE included in the sidelink adaptation layer header.

Aspect 29: The method of any of aspects 27 through 28, further comprising: transmitting, to the second UE, a sidelink message comprising an indication of the local identifier associated with the first UE, the sidelink message comprising a sidelink RRC message.

Aspect 30: An apparatus for wireless communication at a first UE, comprising a processor; memory coupled with the processor; and instructions stored in the memory and executable by the processor to cause the apparatus to perform a method of any of aspects 1 through 17.

Aspect 31: An apparatus for wireless communication at a first UE, comprising at least one means for performing a method of any of aspects 1 through 17.

Aspect 32: A non-transitory computer-readable medium storing code for wireless communication at a first UE, the code comprising instructions executable by a processor to perform a method of any of aspects 1 through 17.

Aspect 33: An apparatus for wireless communication at a base station, comprising a processor; memory coupled with the processor; and instructions stored in the memory and executable by the processor to cause the apparatus to perform a method of any of aspects 18 through 26.

Aspect 34: An apparatus for wireless communication at a base station, comprising at least one means for performing a method of any of aspects 18 through 26.

Aspect 35: A non-transitory computer-readable medium storing code for wireless communication at a base station, the code comprising instructions executable by a processor to perform a method of any of aspects 18 through 26.

Aspect 36: An apparatus for wireless communication at first UE, comprising a processor; memory coupled with the processor; and instructions stored in the memory and executable by the processor to cause the apparatus to perform a method of any of aspects 27 through 29.

Aspect 37: An apparatus for wireless communication at first UE, comprising at least one means for performing a method of any of aspects 27 through 29.

Aspect 38: A non-transitory computer-readable medium storing code for wireless communication at first UE, the code comprising instructions executable by a processor to perform a method of any of aspects 27 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
transmitting, to a base station, a first uplink message comprising one or both of a protocol layer source identifier associated with a second UE or a request for a local identifier associated with the second UE;
receiving, from the base station, a first downlink message comprising a downlink signal radio bearer message, and the downlink signal radio bearer message including one or both of the protocol layer source identifier associated with the second UE or the local identifier associated with the second UE in a downlink adaptation layer header of the downlink signal radio bearer message; and
transmitting, to the second UE, in a sidelink adaptation layer header of a sidelink message, the local identifier associated with the second UE based at least in part on the received first downlink message.

2. The method of claim 1, further comprising:
receiving, from the base station, a second downlink message comprising an indication of a mapping between the protocol layer source identifier associated with the second UE and the local identifier associated with the second UE, wherein the second downlink message comprises a radio resource control reconfiguration; and
transmitting, to the base station, a second uplink message based at least in part on the received second downlink message, the second uplink message comprising a radio resource control reconfiguration complete.

3. The method of claim 2, further comprising:
determining the mapping between the protocol layer source identifier associated with the second UE and the local identifier associated with the second UE based at least in part on the received second downlink message; and
storing the determined mapping between the protocol layer source identifier associated with the second UE and the local identifier associated with the second UE,
wherein transmitting, to the base station, the second uplink message is based at least in part on storing the determined mapping between the protocol layer source identifier associated with the second UE and the local identifier associated with the second UE.

4. The method of claim 2, wherein the radio resource control reconfiguration complete comprises the local identifier associated with the second UE in an uplink adaptation layer header of the radio resource control reconfiguration complete.

5. The method of claim 1, further comprising:
including, in an uplink adaptation layer header of the first uplink message, the indication of the local identifier associated with the second UE, the first uplink message comprising an uplink signal radio bearer message associated with the second UE.

6. The method of claim 1, wherein:
the downlink adaptation layer header of the first downlink message comprises an indication of a mapping between the protocol layer source identifier associated with the second UE and the local identifier associated with the second UE, and
the downlink adaptation layer header of the first downlink message includes or excludes the local identifier associated with the second UE.

7. The method of claim 1, further comprising:
configuring a sidelink bearer associated with a sidelink between the first UE and the second UE based at least in part on the local identifier associated with the second UE, the sidelink bearer comprising a sidelink radio link control bearer; and
transmitting, to the base station, a second uplink message based at least in part on configuring the sidelink bearer associated with the sidelink, the second uplink message comprising an uplink signal radio bearer message, and the uplink signal radio bearer message including the local identifier associated with the second UE in an uplink adaptation layer header of the uplink signal radio bearer message.

8. The method of claim 1, further comprising:
receiving, from the second UE, a second uplink message the second uplink message comprising an uplink signal radio bearer message;
generating a random local identifier associated with the second UE based at least in part on the received second uplink message; and
transmitting, to the base station, a third uplink message, the third uplink message comprising the uplink signal radio bearer message, and the uplink signal radio bearer message including the generated random local identifier associated with the second UE in an uplink adaptation layer header of the third uplink message.

9. The method of claim 8, further comprising:
receiving, from the base station, an indication of a mapping between the local identifier associated with the second UE and a cell-radio network temporary identifier associated with the second UE, wherein the downlink signal radio bearer message includes the local identifier associated with the second UE in the downlink adaptation layer header of the downlink signal radio bearer message.

10. The method of claim 1, further comprising:
receiving, from the second UE, a sidelink message comprising an indication of the local identifier associated with the second UE included in a sidelink adaptation layer header of the sidelink message; and
determining a mapping between the local identifier associated with the second UE and the protocol layer source identifier associated with the second UE based at least in part on one or both of the received sidelink message or the second uplink message.

11. The method of claim 10, further comprising:
storing the determined mapping between the local identifier associated with the second UE and the protocol layer source identifier associated with the second UE.

12. The method of claim 10, further comprising:
including, in the first uplink message, the indication of the local identifier associated with the second UE in an uplink adaptation layer header of the first uplink message based at least in part on the determined mapping between the local identifier associated with the second UE and the protocol layer source identifier associated with the second UE.

13. The method of claim 1, further comprising:
receiving, from the base station, a second downlink message comprising one or both of a random generated local identifier associated with the second UE or the local identifier associated with the second UE, the second downlink message comprising a radio resource control reconfiguration.

14. The method of claim 1, further comprising:
receiving, from the second UE, a sidelink message comprising an indication of the local identifier associated with the second UE, the sidelink message comprising a PC5 radio resource control message.

15. The method of claim 1, wherein receiving, from the base station, the first downlink message is based at least in part on the first UE operating in a connected mode, the first downlink message comprising a handover message.

16. The method of claim 1, further comprising:
establishing a sidelink between the first UE and the second UE in a connected mode based at least in part on receiving a second downlink message, the second downlink message comprising a radio resource control reconfiguration, and the radio resource control reconfiguration comprises a protocol layer identifier associated with the first UE; and
transmitting, to the second UE, a second sidelink message based at least in part on the sidelink bearer configuration from the base station, the second sidelink message including the local identifier associated with the second UE in a sidelink adaptation layer header of the second sidelink message.

17. The method of claim 1, further comprising:
establishing a sidelink between the first UE and the second UE in an idle or inactive mode based at least in part on receiving a second downlink message, the second downlink message comprising a radio resource control reconfiguration, and the radio resource control reconfiguration comprises a protocol layer identifier associated with the first UE; and
transmitting, to the second UE, a second sidelink message based at least in part on a default sidelink bearer configuration, the second sidelink message including the local identifier associated with the second UE in a sidelink adaptation layer header of the second sidelink message.

18. The method of claim 1, further comprising:
receiving an indication of one or both of the local identifier associated with the second UE or an updated local identifier associated with the second UE;
updating a local identifier associated with the second UE based at least in part on the received indication; and
transmitting, to the first UE, or receiving, from the first UE, the updated local identifier associated with the second UE.

19. The method of claim 18, wherein the updated local identifier associated with the second UE is included in one or more of an uplink adaptation layer header, or the downlink adaptation layer header, or the sidelink adaptation layer.

20. A method for wireless communication at a base station, comprising:
receiving, from a first user equipment (UE), a first uplink message comprising one or both of a protocol layer source identifier associated with a second UE or a request for a local identifier associated with the second UE;
assigning the local identifier associated with the second UE based at least in part on the received first uplink message; and
transmitting, to the second UE, a first downlink message indicating the assigned local identifier associated with the second UE.

21. The method of claim 20, further comprising:
determining a mapping between the protocol layer source identifier associated with the second UE and the local identifier associated with the second UE based at least in part on the received first uplink message;
transmitting, to the first UE, the first downlink message comprising an indication of the mapping between the protocol layer source identifier associated with the second UE and the local identifier associated with the second UE, wherein the first downlink message comprises a radio resource control reconfiguration; and
receiving, from the first UE, a second uplink message based at least in part on the transmitted first downlink message, the second uplink message comprising a radio resource control reconfiguration complete.

22. The method of claim 21, wherein the radio resource control reconfiguration comprises one or both of the local identifier associated with the second UE or a protocol layer identifier associated with the first UE.

23. The method of claim 21, further comprising:
receiving, from the first UE, a second uplink message based at least in part on the transmitted first downlink message, the second uplink message comprising an uplink signal radio bearer message, and the uplink signal radio bearer message including the local identifier associated with the second UE in an uplink adaptation layer header of the uplink signal radio bearer message.

24. The method of claim 20, wherein the first downlink message comprises a downlink signal radio bearer message, and the downlink signal radio bearer message including the local identifier associated with the second UE in a downlink adaptation layer header of the downlink signal radio bearer message.

25. The method of claim 20, further comprising:
receiving, from the first UE, a second uplink message, the second uplink message comprising an uplink signal radio bearer message, and the uplink signal radio bearer message including a generated random local identifier associated with the second UE.

26. The method of claim 25, further comprising:
determining a mapping between the local identifier associated with the second UE and a cell-radio network temporary identifier associated with the second UE based at least in part on the received second uplink message; and
transmitting, to the first UE, an indication of the mapping between the local identifier associated with the second UE and the cell-radio network temporary identifier associated with the second UE in the first downlink message, the first downlink message comprising a downlink signal radio bearer message, and the downlink signal radio bearer message including the local identifier associated with the second UE in a downlink adaptation layer header of the downlink signal radio bearer message.

27. The method of claim 20, further comprising:
transmitting, to the first UE, a second downlink message comprising one or both of a random generated local identifier associated with the second UE or the local identifier associated with the second UE.

28. The method of claim 20, further comprising:
updating the local identifier associated with the second UE; and
transmitting, to one or both of the first UE or the second UE, an indication of the local identifier associated with the second UE, the updated local identifier associated with the second UE, or an updated local identifier associated with the first UE.

29. A method for wireless communication at first user equipment (UE), comprising:
receiving, from a base station, a first downlink message comprising a downlink signal radio bearer message, and the downlink signal radio bearer message including a local identifier associated with the first UE in a downlink adaptation layer header of the downlink signal radio bearer message; and
determining the local identifier associated with the first UE based at least in part on the received first downlink message; and
transmitting a first uplink message comprising an indication of the local identifier associated with the first UE, the first uplink message comprising an uplink signal radio bearer message, and the uplink signal radio bearer message comprising a sidelink adaptation layer header, the indication of the local identifier associated with the first UE included in the sidelink adaptation layer header.

30. The method of claim 29, further comprising:
transmitting, to the second UE, a sidelink message comprising the indication of the local identifier associated with the first UE included in the sidelink adaptation layer header.
